(19) United States
(12) Patent Application Publication
(10) Pub. No.: US 2026/0148100 A1
(43) Pub. Date: May 28, 2026

(54) COMPUTER-IMPLEMENTED SYSTEM AND METHOD FOR ARTIFICIAL INTELLIGENCE (AI)-DRIVEN INTERACTIVE KNOWLEDGE BASE EVALUATION

(71) Applicant: The Texas A&M University System, College Station, TX (US)

(72) Inventors: Rujun GAO, College Station, TX (US); Arun Srinivasa, College Station, TX (US)

(21) Appl. No.: 18/961,269

(22) Filed: Nov. 26, 2024

(51) Int. Cl. G06N 5/022

(52) U.S. Cl. CPC G06N 5/022

(57) ABSTRACT

A computer-implemented method for artificial intelligence (AI)-driven interactive knowledge base evaluation, the method comprising receiving queries; generating responses to the queries, wherein the generating comprises initiating a large-language model (LLM) to generate, based on a first database comprising knowledge materials provided by different instructors, an individual one of the responses to a respective one of the queries; storing, in a second database, the queries in association with respective ones of the responses; determining an association between each of the responses generated by the LLM and a respective one of the knowledge materials; comparing an effectiveness of the knowledge materials based on the determined association; generating, based on the comparing, a report indicating that a first knowledge material of the knowledge materials associated with a first instructor of the instructors is more effective than a second knowledge material of the knowledge materials associated with a second instructor of the instructors.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Student-teacher interaction is an important part of a learning process for students and an important part of a teaching process for teachers. For example, a teacher may teach certain lessons to a class of students in a physical classroom or virtually online. As part of the teaching process, the teacher may utilize certain teaching materials (e.g., textbooks) and/or generate their own teaching materials (e.g., class notes, lecture notes, presentation slides, etc.). The teacher may also create homework assignments, quizzes, and/or exams to assess the student's understanding and knowledge of the taught lessons. As part of the learning process, the students may attend classes, work on their homework assignments, and take quizzes and/or exams. Additionally, the students may ask the teacher questions and may receive answers from the teacher. In a higher-educational institution (e.g., a university), a professor may teach multiple classes with many students (e.g., hundreds of students), thus it may be impractical for the professor to personally answer each student's question. Teaching assistants are commonly used to enhance student's learning experience and bridge the gap between students and professors. As computer technologies (e.g., using artificial intelligence (AI)) advance, there is a continual demand to integrate computer technologies to enhance the educational process.

### SUMMARY

In an embodiment, a computer-implemented method for providing artificial intelligence (AI)-driven interactive knowledge base question-answering based on multiple large-language model (LLM) iterations with separate software tools for LLM evaluation is disclosed. The method comprises receiving, by an application comprising instructions stored in non-transitory memory of a computer system and executable by a processor of the computer system, a query in natural language; generating, by the application, based on the query, one or more prompts comprising contextual information associated with the query, and a reference to a knowledge database associated with the query; initiating, by the application, a first LLM to generate, based on the one or more prompts and the knowledge database, a first response to the query; receiving, by the application, from the first LLM, the first response to the query; evaluating, by the application, an accuracy of the first response using at least one software tool separate from the first LLM, wherein the evaluating comprises determining whether the first response satisfies one or more criteria; initiating, by the application, based on the first response from the first LLM satisfying the one or more criteria, a second LLM to generate a final response in natural language based on the one or more prompts and the first response from the first LLM; and providing, by the application, the final response to the query.

In another embodiment, a computer-implemented method for providing interactive natural language-based, course-specific assistance to students using artificial intelligence with reinforcement learning from human instructor feedback is disclosed. The method comprises receiving, by a natural language-based teaching assistant (TA) agent comprising instructions stored in non-transitory memory of a computer system and executable by a processor of the computer system, from a student computing device, a student query in natural language; generating, by the natural language-based TA agent, based on the student query, one or more prompts comprising contextual information associated with the student query, and a reference to a knowledge database comprising knowledge information associated with a specific course; providing, by the natural language-based TA agent, the one or more prompts, the student query, and the knowledge database as an input to an LLM for processing; receiving, by the natural language-based TA agent, from the LLM, a response to the student query based on the processing; transmitting, by the natural language-based TA agent, to the student computing device, the response to the student query; receiving, by the natural language-based TA agent, from the student computing device, an indication that the response from the LLM is unsatisfactory; transmitting, by the natural language-based TA agent based on the response from the LLM being unsatisfactory, to a computing device associated with a human instructor, the student query; receiving, by the natural language-based TA agent, from the computing device associated with the human instructor, a modified response to the student query; and transmitting, by the natural language-based TA agent, to the student computing device, the modified response.

In yet another embodiment, a system for providing interactive natural language-based educational assistance to students using one or more large-language models (LLMs) and a knowledge database with continual augmentation to the knowledge database based on instructor-student interactions is disclosed. The system comprising at least one processor; at least one non-transitory memory; a knowledge database comprising course materials for at least one specific course; an experience database comprising a history of student queries and corresponding responses; and a natural language-based TA agent comprising instructions stored in the at least one non-transitory memory and executable by the at least one processor, when executed by the processor, causes the natural language-based TA agent to receive, from a student computing device, a student query in natural language; generate, based on the student query, at least one prompt comprising a question different than the student query or a statement associated with the student query; and an action to search the knowledge database; initiate, an LLM to generate, based on the at least one prompt, a response to the student query; receive, from the LLM, the response in natural language; cause the student computing device to render a display of the response to the student query; receive, via an instructor computing machine, human instructor feedback associated with the response from the LLM; store, in the experience database, the student query, the response from the LLM, and the human instructor feedback; and promote, based on the human instructor feedback being positive, the student query and the corresponding response from the experience database to the knowledge database.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, where like reference numerals represent like parts.

FIG. 1 is a block diagram of a network system that provides interactive natural language-based teaching assistance to students using large language models (LLMs) according to an embodiment of the disclosure.

FIG. 2 is a sequence diagram illustrating an example method for providing interactive natural language-based teaching assistance to students according to an embodiment of the disclosure.

FIGS. 3A and 3B are flow charts illustrating an example method for providing interactive natural language-based teaching assistance to students according to an embodiment of the disclosure.

FIGS. 4A-4B are block diagrams illustrating example user interfaces according to an embodiment of the disclosure.

FIG. 5 is a block diagram illustrating an example method for providing teaching feedback for an individual instructor according to an embodiment of the disclosure.

FIG. 6 is a block diagram illustrating an example method for providing teaching feedback across multiple instructors teaching the same course according to an embodiment of the disclosure.

FIG. 7 is a flow chart of a method according to an embodiment of the disclosure.

FIG. 8 is a flow chart of another method according to an embodiment of the disclosure.

FIG. 9 is a flow chart of yet another method according to an embodiment of the disclosure.

FIG. 10 is a flow chart of yet another method according to an embodiment of the disclosure.

FIG. 11 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The terms “teacher,” “professor,” “educator,” and “instructor” may be used interchangeably herein, such that a description referring to one of the terms shall be treated as though the description also referred to the other term. Further, the terms “teacher,” “professor,” “educator,” and “instructor” may refer to a human instructor unless otherwise stated.

The terms “course materials,” “learning materials,” and “teaching materials” may be used interchangeably herein, such that a description referring to one of the terms shall be treated as though the description also referred to the other term.

Natural language processing (NLP) is a branch of artificial intelligence (AI) technology that focuses on interaction between computers and humans through natural language. For instance, NLP may use machine learning (ML) to provide computers with the ability to interpret, manipulate, comprehend, and extrapolate human language and to respond using human-like language. Recent advancements in NLP include the development of large-language models (LLMs) (e.g., including generative pre-trained transformer (GPT) models and bidirectional encoder representations from transformer (BERT) models). An LLM may have a large number of parameters (e.g., thousands, millions, or billions of parameters) trained on large datasets (e.g., text data). The LLM may be trained to learn complex patterns and dependencies in language to generate text (e.g., for answering questions) that is coherent, contextually relevant, and often indistinguishable from text written by humans.

As discussed above, teaching assistants (TAs) are commonly used to enhance student learning experience and to bridge the gap between students and teachers or professors. In a university setting, many professors may not teach directly from textbooks as that may not reflect the professors'voice. Instead, the professors may prepare their own lecture notes, teach their students to solve problems using their own approaches, and expect their students to answer questions in homework assignments, quizzes, and/or exams using those approaches. Thus, a TA for a particular class of students taught by a particular professor may utilize course materials (e.g., lecture notes, presentations, questions and answers, audio recordings of lectures, and/or video recordings of lectures) prepared by the respective professor to guide and assist those students in understanding lessons taught by that particular professor. More specifically, the TA may review the course materials with the students, guide the students in completing their homework assignments (e.g., solving problems using a particular approach taught by the professor), and/or explain the answers to certain questions in past quizzes and/or exams (e.g., as expected by the professor). Generally, the students may ask questions about the lessons, homework, and/or test results for that class, and the TA may provide answers according to the course materials prepared by the particular professor. Using human TAs to bridge the gap between students and professors can be costly and not easily scalable. Additionally, students may be limited to receiving assistance from a TA only during certain office hours and at a certain location.

From the teaching perspective, a professor may desire to gain insights into the student learning performance so that the professor may improve their teaching approach and better connect to the students. One way for the professor to assess the student learning performance is to gather student work products from homework assignments, student answers to reading comprehension questions directed to texts, notes, and/or videos related to the class or course, and student grades from tests (e.g., quizzes and/or exams). Another way is for the professor to ask a TA for insights into the student learning performance (e.g., prior to receiving homework and test results from the students). For instance, the professor may ask a TA: “what concept do my students struggle with the most?” However, the insights provided by the TA may be subjective and may or may not be accurate. To gain insights into teaching approaches or instructional styles, the professor may ask students for feedback (e.g., via surveys) regarding their teachings (e.g., their class notes, presentations, teaching style, etc.). However, some students may ignore the surveys or be reluctant to provide any feedback to the professor.

With the recent advancements in LLM technologies (e.g., Chat GPT), chatbots using LLMs can be developed to converse with students and answer student questions related to their studies. Unfortunately, the nature of LLM introduces unpredictability in LLM responses. For instance, an LLM may provide a response that is inaccurate or false. In some cases, LLM responses to questions may have subtle but critical errors that can only be identified by instructors or experts. Additionally, an LLM may simply provide answers to a student's specific question or homework assignment without the specific focus to guide the student in learning a concept and thinking through the steps to solve a problem by themselves, let alone a professor-specific problem-solving approach. Thus, using chatbots that are based on currently available LLMs can have a negative impact on student learning. Further, there is a lack of a model that can promote student-teacher interactions and provide insights and/or feedback to a teacher or professor.

The present disclosure provides a technical solution to the aforementioned technical problems in the technical field of NLP-based or AI-based educational assistance. The present disclosure provides an interactive NLP-based, course-specific, and/or instructor-specific educational assistance computer system (e.g., an integrated computer system platform) that can enhance learning experience for students, teaching experience for teachers, and student-teacher interactions. More specifically, the present disclosure provides an advanced architecture for an intelligent TA system (referred to as a “ChaTA system” hereinafter) that can provide efficient, context-aware responses to student inquiries using multiple LLMs. To provide course-specific and/or instructor-specific teaching assistance, the ChaTA system utilizes a knowledge database built from course-specific and/or instructor-specific course materials and utilizes LLMs to generate responses to student queries using the knowledge database. To verify the accuracy of responses generated by an LLM, the ChaTA system utilizes software tools (e.g., mathematical software, software development tools, course-specific software and simulators, other LLM(s), etc.) independent of (separate from) the LLM that generated the response. The ChaTA system may only provide an LLM generated response to a student query after the LLM generated response is verified to be accurate. To promote student-teacher interaction and enable reinforcement learning with human feedback (RLHF), the ChaTA system includes a student-teacher communication channel or pipeline that enables a student to communicate with a human instructor when an LLM generated response to a student query is unsatisfactory (e.g., the response is incomplete, does not make sense, seems inaccurate, and/or, generally, does not answer the student query). The communication channel also enables a human instructor to provide feedback about an LLM generated response to a student query. For instance, the human instructor may indicate, via the communication channel, that an LLM generated response is accurate (e.g., in alignment with the respective course materials) or provide a modified response when an LLM generated response is inaccurate. The ChaTA system (e.g., parameters of the LLMs and/or the content of the knowledge database) may be fine-tuned based on feedback from the student and/or the human instructor.

According to an embodiment of the present disclosure, a network system for providing interactive NLP-based, course-specific, and/or instructor-specific teaching assistance to students may include a knowledge database (e.g., a first database), an experience database (e.g., a second database), multiple LLMs, and a ChaTA system. The knowledge database may include course-specific and/or instructor-specific course materials and/or course-specific logistic information. The course materials may include, for example, but are not limited to, textbooks, class notes, presentation slides (e.g., Microsoft PowerPoint presentations), documents (e.g., Microsoft Word documents, portable document format (PDF) documents), audio and/or video recordings of lectures or lessons, transcripts of lecture or lesson recordings for a specific course and/or prepared by a specific instructor. The course-specific logistic information may include, for example, but is not limited to, course enrollment information, course syllabus, professor office hours, human TA office hours, homework schedules, quizzes schedules, and exam schedules. The ChaTA system may include a natural language-based TA agent (which may be referred to as a ChaTA agent) including instructions stored in memory of the ChaTA system and executable by a processor of the ChaTA system. The natural language-based TA application may communicate with a student and a human instructor respectively via a student client application executing on a computing device of the student and an instructor client application executing on a computing device of the instructor.

At a high level, the natural language-based TA agent (e.g., a server application) may communicate with the student client application to receive student queries from the student. The natural language-based TA application may utilize one or more of the LLMs to generate responses to the student queries using the knowledge database. The student and/or the human instructor may provide feedback about responses generated by an LLM. The student may also request a response from the human instructor upon receiving an unsatisfactory response generated by an LLM. The natural language-based TA application may cache or store a history of student queries and corresponding responses communicated with the student and/or the human instructor in the experience database. To ensure data privacy, the knowledge database and the experience database may be stored in a private network system of an educational institution (e.g., university, college, school) and the LLMs may be executed locally on a computer system (e.g., the ChaTA system) within the private network system.

In an embodiment, the natural language-based TA agent may receive a student query in natural language from the student client application executing on the student computing device. Upon receiving the student query, the natural language-based TA application may apply a query filter to the student query to eliminate a list of questions of particular type(s) (e.g., irrelevant or offensive). The filtering may include keyword filtering (e.g., using keyword searches) and/or content filtering (e.g., using sentiment analysis with LLM processing). If the student query is of one of the particular type(s) (i.e., irrelevant or offensive), the natural language-based TA agent may return a response, for example, indicating that the student query cannot be answered. Otherwise, the natural language-based TA agent may proceed to generate one or more system prompts (e.g., multiple system prompts) based on the student query. Generally, the filtering may be applied to eliminate questions that are unassociated with any one of the learning concepts or learning goals of the specific course. The system prompts may be used to guide (or prompt) an LLM in generating a response to the student query. More specifically, the system prompts may indicate which course is associated with the student query, who is the instructor, and where the LLM can find course materials or information to answer the student query. The system prompts may also provide specific instructions (e.g., step-by-step instructions) to guide the LLM in determining a response to the student query. For instance, the system prompts may include a list of questions that the LLM may answer to guide the student in understanding a certain concept requested by the student query. As an example, the student query may be “what is circuit modelling?”, and the system prompts may include a list of questions, such as, “What are basic circuit components? What are the different types of circuits? What are the different types of circuit modelling techniques? What are some examples of circuit simulation software?” to guide the LLM in providing information that may explain circuit modelling to the student. Stated differently, the natural language-based TA agent is to convert a student query (which may be vague) into a sequence of directed prompts based on the student query and the learning objectives of the class. In some instances, the system prompts may further include an output configuration including a textual description of instructions, example question and response pairs, and/or an output format (e.g., certain syntax, sentence structure, programming code format, etc.) that the LLM may follow to provide a final answer to the student query.

Stated differently, the system prompts may include contextual information, a reference to the knowledge database, and/or a reference to the experience database based on the student query. The context information may include an indication of a certain subject or course (e.g., a math course, a programming course, an engineering science course, etc.) associated with the student query. In some examples, a school or university may offer multiple classes for the same course but may be taught by different instructors. Thus, the contextual information may also include an indication of a certain instructor associated with the student query. The context information may further include a list of specific instructions to guide an LLM in providing information relevant to the student query. The contextual information may further include a guardrail to limit an LLM output to be within the scope of the specific course. The contextual information may further include an output configuration (e.g., including an example question-response pair, or an output response form or structure) to guide an LLM in generating a final output or final answer for the student query. The reference to the knowledge database may be determined based on the contextual information (e.g., the class or course indication). For instance, the knowledge database may include multiple course-specific and/or instructor-specific knowledge databases and the reference may include an indication (e.g., a storage path or a link) to the corresponding course-specific and/or instructor-specific knowledge database. Similarly, the experience database may be based on the course indication and/or the instructor indication in the contextual information. For instance, the experience database may include multiple course-specific and/or instructor-specific experience databases and the reference may include an indication (e.g., a storage path or a link) to the corresponding course-specific and/or instructor-specific experience database. In an embodiment, the knowledge database and/or the experience database may be stored in a vector database format to provide efficient search.

Next, the natural language-based TA agent may determine a category or a classification of the student query. In some examples, the natural language-based TA agent may utilize a classifier, an ML model, or an LLM to perform the classification. In an example, student queries may be classified into a general question category, a knowledge question category, or a deep reasoning question category. The general question category may include queries that are not related to a specific course and do not require information from the knowledge database. The knowledge question category may include queries that are related to a specific course and require information (e.g., excerpts of course materials, such as documents, slides, audio and/or video recordings) from the knowledge database. The deep reasoning question category may include queries that require reasoning rather than simply course-specific knowledge and may or may not require information from the knowledge database depending on the student query. As an example, a query under the general question category may be “what is python programming language used for?”, a query under the knowledge question category may be “can you provide example guidelines for solving homework XXX in computing class YYY?”, and a query under the deep reasoning category may be “what is wrong with this python script?”.

Based on the classification or category associated with the student query, the natural language-based TA agent may select a particular LLM (e.g., a first LLM) from the multiple LLMs. The LLMs may include, for example, but are not limited to, one or more OpenAI® models (e.g., a GPT-3 model, a GPT-3.5 model, a GPT-4 model), one or more open-source LLMs, an LLM Meta AI (Llama) model, and a Google Gemini® model. The different LLMs may have different performances. For instance, the different LLMs may have different architectures (e.g., different transformers) and may be trained on different types of datasets and/or different amounts of data. The different LLMs may also have different associated costs (e.g., in terms of computational resources, memory resources, and/or subscription or service costs for using the respective LLMs). Generally, the higher the performance of the LLM, the higher the cost. In an example, a high-performance (or heavy-weight) LLM may be good at answering questions that require deep insights or deep reasoning, a mid-performance (or mid-weight) LLM may be sufficient for answering knowledge (e.g., course-specific) related questions, and a low-performance (or lightweight) LLM may be sufficient for answering general questions. Accordingly, selecting a particular LLM based on the category or classification of the student query can reduce processing and cost. Generally, there may be any suitable number of question categories (e.g., 2, 3, 4 or more), each mapped to a different one of the LLMs.

To further reduce the amount of processing and/or cost, the natural language-based TA agent may first check whether there is an available response to the student query stored or cached in the experience database. In some examples, the natural language-based TA agent may utilize a semantic search or an LLM (e.g., a lightweight LLM) to perform the check. If there is an available response cached in the experience database, the natural language-based TA agent may provide the student with the cached response instead of invoking a heavyweight or costly LLM to generate a response. If, however, there is no available response to the student query cached in the experience database, the natural language-based TA agent may then initiate the selected LLM (e.g., via an application programming interface (API) call) to generate, using the knowledge database, a response to the student query based on the system prompts and the user prompt (the student query).

In an embodiment, the natural language-based TA agent may utilize a retrieval-augment generation (RAG) process to retrieve relevant information from the knowledge database. Generally, RAG is a technique for enhancing the accuracy and reliability of a generative AI model with facts fetched from external sources (e.g., an authoritative knowledge base outside of the training data sources used for training the AI model). The natural language-based TA agent may further instruct the selected LLM to use the retrieved information for generating the response to the student query. As discussed above, the knowledge database may be stored in a vector database format. When utilizing RAG, the RAG process may identify multiple pieces of information (e.g., top 10 relevant information pieces, which may include document(s), presentation slide(s), audio and/or video recording(s)) from the knowledge database based on a similarity measure (e.g., a cosine similarity measure), and the selected LLM may generate the response to the student query using the identified information pieces. In an embodiment, the natural language-based TA agent may further apply a ranking process to narrow down the number of information pieces identified from the RAG process. For instance, the ranking process may identify a subset of the information pieces (e.g., the top 5 out of the 10 relevant information pieces) identified from the RAG process, and the selected LLM may use the subset of the information pieces to generate the response to the student query. In some examples, the natural language-based TA agent may utilize ML (e.g., a maximum marginal relevance (MMR) model) to perform the ranking.

In response to the initiation of the selected LLM, the natural language-based TA agent may receive returned data (e.g., a first response including textual data) from the selected LLM. The natural language-based TA agent may decode the returned data from the selected LLM. For instance, the decoding may include parsing the first response into a specific format. To ensure that the first response generated by the selected LLM (the decoded returned data) is accurate, the natural language-based TA agent may execute software tool(s) to confirm the accuracy of the first response from the selected LLM. The software tool(s) may be independent of (separate from) the selected LLM (that generated the first response). Based on the execution of the software tool(s), the natural language-based TA agent may determine whether the first response from the selected LLM satisfies one or more criteria. As an example, the student query may request for a python code example to delete a certain word from a document, and the selected LLM may generate a piece of python code to delete the certain word from a document. The software tool(s) may include a python code simulator/debugger that can execute the piece of python code (generated by the selected LLM). To test the LLM generated python code, the natural language-based TA agent may provide an input document including the certain word (to be deleted) as an input to the python code, execute the LLM generated python code in the python code simulator/debugger, and check that an output document generated from the execution of the LLM generated python code does not include the certain word. Stated differently, in such an example, the one or more criteria may include checking that the LLM generated python code can execute without errors and that the output of the python code is as expected.

If the natural language-based TA agent determines that the LLM generated response is inaccurate (e.g., failing to satisfy the one or more criteria), the natural language-based TA agent may repeat the process of initiating the selected LLM to generate a response to the student query based on the system prompts and user prompts and using the knowledge database (e.g., the relevant and/or narrowed down information pieces identified from the RAG process). In some instances, the natural language-based TA agent may also make observations based on the evaluation and provide additional feedback information to the selected LLM when repeating the initiation of the selected LLM.

If, however, the natural language-based TA agent determines that the LLM generated response is accurate (e.g., satisfying one or more criteria), the natural language-based TA agent may initiate a second LLM to generate a final answer or final response in natural language to the student query. In some examples, the second LLM may be the same as the selected LLM. In other examples, the second LLM may be different than the selected LLM. As part of the initiation, the natural language-based TA agent may provide the system prompts, the student query, and the most recent data received from the selected LLM (that is confirmed to be accurate) as an input to the second LLM. In an example, the second LLM may generate the final answer according to the output configuration included in the system prompts. Subsequently, the natural language-based TA agent may receive the final answer from the second LLM. Upon receiving the final answer, the natural language-based TA agent may provide the final answer to the student by transmitting the final answer to the student client application. In an embodiment, the natural language-based TA agent may store the student query and the final answer in the experience database.

To enhance student learning experience and student-teacher interactions, the natural language-based TA agent may allow the student and/or human instructor to provide feedback about the final answer provided by an LLM (e.g., the second LLM). In an embodiment, if the student is unsatisfied with the final answer provided by the LLM, the student may query the human instructor. For instance, the natural language-based TA agent may subsequently receive an indication that the final answer is unsatisfactory, where the indication may include the same student query but directing to the human instructor (e.g., the professor that teaches the specific course). Upon receiving the student query directing to the human instructor, the natural language-based TA agent may forward the student query to the instructor client application executing on the computing device of the human instructor. In response, the natural language-based TA agent may receive a modified (or corrected) answer from the human instructor via the instructor computing device.

Subsequently, the natural language-based TA agent may provide the modified answer to the student by transmitting the modified answer to the student client application. When the final answer based on the LLM generated response is unsatisfactory, the natural language-based TA agent may store the student query and the instructor modified or corrected answer to the experience database. Generally, the student and/or the human instructor can provide feedback to LLM generated responses, and the natural language-based TA agent may store student queries and corresponding answers, student feedback, and/or instructor feedback in the experience database.

In an embodiment, the natural language-based TA agent may periodically (e.g., hourly, daily, biweekly, or monthly) check to determine if any student query and corresponding answer are to be promoted from the experience database to the knowledge database. For instance, an answer provided by the human instructor and/or with an LLM generated answer with positive instructor feedback (approving or “liking” the LLM generated answer) may be considered as a golden answer to be promoted. The natural language-based TA agent may store the promoted data (e.g., a student query and a corresponding answer) in the knowledge database. After promoting the data to the knowledge database, the natural language-based TA agent may remove the promoted data from the experience database. Accordingly, the knowledge database may continually be augmented and enriched. In an embodiment, the natural language-based TA agent may update (fine-tune) parameters of an LLM based on positive and/or negative feedback from the student, positive and/or negative feedback from the human instructor, and/or corrected responses from the human instructor. In some examples, the fine-tuning may apply different weights (or rewards) based on whether the feedback is from the student or the human instructor. For instance, human instructor feedback may be assigned with a higher weight than student feedback. Accordingly, the LLM(s) can be continually fine-tuned to improve the performance and/or accuracy of the LLM(s).

In an embodiment, the natural language-based TA agent may summarize student queries and correspond answers (generated by LLMs and/or from a human instructor) into a frequency question answer (FAQ) list and publish the FAQ list in a dashboard (e.g., a web server). For instance, the natural language-based TA agent may publish the student query and the final answer (or the modified answer when the final answer is unsatisfied) in the dashboard. The dashboard may be a public dashboard that can be accessed by all students in the class, and thus may further enhance student learning experience. In some instances, a student may check the dashboard for an answer to a question prior to sending the question to the ChaTA system. In an embodiment, the natural language-based TA agent may further generate and/or provide various information to assist the student in learning the course materials. For instance, the natural language-based TA agent may generate a student profile including progress tracking information (e.g., personalized study schedules and progress tracking, such as learning progress and data analytics). Additionally or alternatively, the natural language-based TA agent may provide study group coordination based on the students' learning profiles and data analytics (e.g., the students' quantitative learning data from quizzes and/or homework assignments and the students' qualitative learning data such as conversations with the natural language-based TA agent). For instance, the natural language-based TA agent may recommend a suitable study buddy for a student based on that student's learning profiles and data analytics. Additionally or alternatively, the natural language-based TA agent may provide note summarization and organization to assist students in their studies.

According to a further embodiment of the present disclosure, the ChaTA system may further include a teaching feedback generator including instructions stored in the memory of the ChaTA system and executable by the processor of the ChaTA system. As discussed above, the natural language-based TA agent may converse with students to provide responses to student queries using LLM(s) and the course materials in the knowledge database and/or request responses from a human instructor (e.g., when an LLM generated response is determined to be unsatisfactory by a student). The natural language-based TA agent may also store student queries in association with corresponding responses (LLM generated responses and/or human instructor generated responses) in the experience database. In an embodiment, the teaching feedback generator may utilize the student queries and corresponding responses (which may be referred to as student query-response data) collected in the experience database to generate a teaching feedback report for a specific human instructor (who provided the course materials and taught the students who generated those student queries). The teaching feedback report may include an indication of a student learning performance, for example, indicating student learning difficulties in certain learning concepts associated with the specific course. The learning concepts may correspond to learning objectives or goals defined for the specific course. The teaching feedback report may also include an indication of the effectiveness of the course materials (prepared by the specific human instructor) in teaching certain learning concepts associated with the specific course. The effectiveness of the course materials may be assessed based on whether there are issues with the course materials in teaching certain learning concepts (e.g., in terms of the content, language, and instruction styles) and/or whether there is any concept missing in the course materials.

For example, to determine the student learning performance, the teaching feedback generator may retrieve the student queries from the experience database, classify each of the retrieved student queries into one or more of the learning concepts or learning goals (e.g., using a classifier, a ML model, or an LLM). The teaching feedback generator may determine a student learning difficulty in a first learning concept of learning concepts based on the number of student queries associated with the first learning concept being high (e.g., meeting or exceeding a certain threshold). In some instances, the teaching feedback generator may also determine the top X (e.g., 1, 2, 3 or more) number of learning concepts with which the student struggled most (e.g., by identifying those learning concepts that are associated with the highest number of student queries among all the learning concepts). Stated differently, the teaching feedback generator may generate a list of FAQs from the retrieved student queries, and the learning concepts covered by the FAQs may indicate learning concepts that the students may have difficulties in learning.

The teaching feedback generator may also identify, for each of the retrieved responses that are generated by the LLM(s), a corresponding portion of the course materials from the knowledge database that was referenced or included by the respective response generated by the LLM(s). The teaching feedback generator may analyze the identified portions of the course materials to determine the effectiveness of the course materials. For instance, the teaching feedback generator may classify each of the identified portions of the course materials into one or more of the learning concepts (e.g., using a classifier, a ML model, or an LLM). The teaching feedback generator may determine an issue associated with a certain learning concept in the course materials based on a number of the identified portions of the course materials associated with the certain concept being high (e.g., meeting or exceeding a certain threshold). The issue may be associated with the content, the language, and/or the instructional style. The teaching feedback generator may further analyze the content, the language, and/or the instructional style in the identified portions of course materials (e.g., using ML or LLMs) to determine the reasons for having a large number of student queries directed to those portions of course materials. As an example, the teaching feedback generator may flag an issue based on the inconsistent use of certain diagrams (e.g., free body diagrams) across the course materials. As another example, the teaching feedback generator may flag an issue based on the course materials providing different explanations for similar topics (e.g., forces or moments). As yet another example, the teaching feedback generator may flag an issue based on a textual or verbal description in the course materials needs some supplementary picture for better clarity. To analyze the course materials and flag these issues, the teaching feedback generator may compare the texts in these differing portions of the course materials. The teaching feedback generator may also flag these issues based on the number of queries related to the particular concept (e.g., greater than a certain threshold), the amount of time the students lingered on the videos associated with these particular portions (e.g., longer than a certain duration), or the percentage of students giving wrong answers to conceptual quizzes generated based on the course materials (e.g., greater than a certain percentage threshold). As a further example, the teaching feedback generator may flag that there was not enough discussion of torques when discussing free body diagrams (e.g., related texts or paragraphs is below a certain threshold), causing the natural language-based TA agent to be unable to answer a particular question and has to elevate the question to the TA or the instructor.

The teaching feedback generator may also determine issues in the course materials and/or learning concepts that are covered by the course materials based on the retrieved responses that are generated by the human instructor. For instance, the teaching feedback generator may compare each human instructor generated response to information provided in the course materials (e.g., using semantic searches, ML, and/or LLMs) to determine whether there is a discrepancy in the course materials. The discrepancy may be the course materials provide different or contradicting information compared to the respective human instructor generated response. Alternatively, the discrepancy may be the course materials do not cover certain knowledge information provided by the respective human instructor generated response.

In some scenarios, multiple classes for the same course may be taught by different professors or instructors. Thus, the knowledge database may include different course materials prepared by different instructors for the same course, and the experience database may include student query-response data associated with the different course materials and different instructors. Accordingly, in an embodiment, the teaching feedback generator may generate a teaching feedback report to provide an assessment across the different instructors (or more specifically, across the different course materials) based on the student query-response data retrieved from the experience database. The teaching feedback report may include an indication of an effectiveness comparison or ranking among the different course materials in teaching certain concepts. To that end, the teaching feedback generator may link each of the LLM generated responses in the student query-response data to a corresponding course material prepared by the respective instructor (e.g., using ML and/or LLMs). Stated differently, the teaching feedback generator may determine an association between each of the LLM generated responses and a respective one of the different course materials. The teaching feedback generator may compare the effectiveness of the different course materials (provided by the different instructors) in teaching a certain concept based on the determined association.

For instance, the teaching feedback generator may compare a number of the LLM generated responses that are associated with a portion of a first course material (prepared by a first instructor) for teaching a particular concept to a number of the LLM generated responses that are associated with a portion of a second course material (prepared by a second instructor) for teaching the same particular concept. The teaching feedback generator may determine that the course material associated with the smaller number of LLM generated responses may be more effective in teaching the certain concept as less student queries related to that course material are received. As an example, the teaching feedback generator may determine that the first instructor may be more effective based on fewer students asked questions related to the first course material or that the students give a higher rating to the answers provided by the first instructor. As part of comparing the effectiveness of the different course materials, the teaching feedback generator may further determine a difference in instructional styles (e.g., via textual, visual diagrams, problem solving examples, etc.) between the portion of the first course material associated with the particular concept and the portion of the second course material associated with the particular concept. The teaching feedback generator may further determine a difference in content (e.g., the actual learning information) between the portion of the first course material associated with the particular concept and the portion of the second course material associated with the particular concept. In some instances, for each course, there may be corresponding exercises, quizzes, and information collected by the natural language-based TA agent. As such, the teaching feedback generator can collect comprehensive students' data by topics or concepts. Thus, the teaching feedback generator may have statistics of students' overall performance by topics. For instance, if the performance of students being taught using a certain course material is higher than another course material, the certain course material is more effective. Additionally, students' engagements may be another indicator (e.g., based on the number of queries and feedback collected by the natural language-based TA agent). Generally, the teaching feedback generator may use a variety of metrics to determine the effectiveness of course materials. The metrics may include, for example, but are not limited to, students' average performance (e.g., quiz scores) by different course materials, students'engagements analytics, student conversational information (e.g., the number of questions related to the same topic or concept), and student feedback (or satisfaction indications).

In some higher-level education scenarios, the same course (e.g., mathematics) may be taught in different classes offered by different faculties (e.g., an engineering faculty and a general science faculty). For instance, the first course material may be associated with a first faculty, and the second course material may be associated with a second faculty different than the first faculty. Thus, the teaching feedback generator may also provide an assessment of student learning performance and/or teaching performance for the same course across faculties. In some instances, a professor may rework how they teach a concept based on the feedback. In some instances, a professor may adopt the teaching style on a particular concept as another professor (who provided the more effective course materials). In some instances, the knowledge base may be updated or fine-tuned on a particular concept, for example, by modifying the course materials of a professor based on the course materials of the other professor who achieved the better teaching performance. As an example, in teaching the concept of gradient of a function, the teaching feedback generator may compare two different explanations or examples by two instructors (e.g., a first instructor and a second instructor) and suggest alternative approaches to the second instructor based on the first instructor's explanation. This in turn can help the second instructor to use the explanation of the first instructor in their class. As student feedback (and formative assessments) accumulates as discussed above, the teaching feedback instructor may point to one explanation example being more effective based on a comparison of the number of student queries and/or the assessment scores of the students. Generally, the teaching feedback generator may utilize the metrics discussed above to determine the effectiveness of course materials across faculties.

Providing LLMs in an interactive NLP-based education assistance system with course-specific and/or instructor-specific knowledge database can provide students with teaching assistance that is consistent and aligned with expectations of corresponding instructors. The interactive NLP-based educational assistance system can save educators'time and energy for answering general queries and/or at least some course-specific queries. The interactive NLP-based educational assistance system can also provide students with real-time feedback and guidance without being limited to certain TA or professor office hours and/or being at certain office or classroom locations. Storing a knowledge database and/or an experience database and/or executing LLMs locally at a private network system of an education institution can ensure data privacy. Evaluating the accuracy of LLM generated responses prior to providing the LLM generated responses to students can ensure that the students are given accurate information. Providing a communication channel or pipeline between students and instructors within the interactive NLP-based education assistance system can enable human instructors to correct LLM generated responses and promote student-teacher interactions. Feedback from students and/or human instructors and/or corrected responses from human instructors can be used to fine-tune parameters of LLMs, and thus the performance and/or the accuracy of the LLMs can be continually enhanced. Tracking and storing exchanges between a ChaTA system and students and/or human instructors in an experience database and using stored (or cached) responses whenever possible can reduce processing complexity and/or cost. Further, promoting student queries and corresponding responses from the experience database to the knowledge database based on positive feedback from the human instructor can allow the knowledge database to be continually augmented and enriched. Using different LLMs (of different performances and/or different costs) for different types of student queries can allow for processing and cost reduction.

Collecting student query-response data generated from the interactive NLP-based education assistance system that uses a knowledge database with course-specific and instructor-specific course materials can provide valuable insights into student or class learning performance and teaching performance (e.g., effectiveness of course materials). For instance, at an individual level, an instructor feedback report can be generated for a specific instructor based on student query-response data associated with the specific instructor and specific course materials provided by that instructor. At a group level, an instructor assessment report can be generated based on student query-response data associated with the same course but different instructors to provide a comparison of teaching performances across different instructors that teach the same course. At an institution level, an assessment report can be generated based on student query-response data associated with the same course but across different faculties to provide a comparison of student learning performances and/or teaching performances among different instructors across different faculties. In some instances, best practices for instructors and/or provisioning of course materials may be developed based on the feedback reports across instructors and/or across faculties. These best practices may also be useful for new instructors. The interactive NLP-based educational assistance and teaching feedback mechanisms may be suitable for use in any educational institutions (e.g., schools, colleges, universities) and/or any organizations that provide educational training.

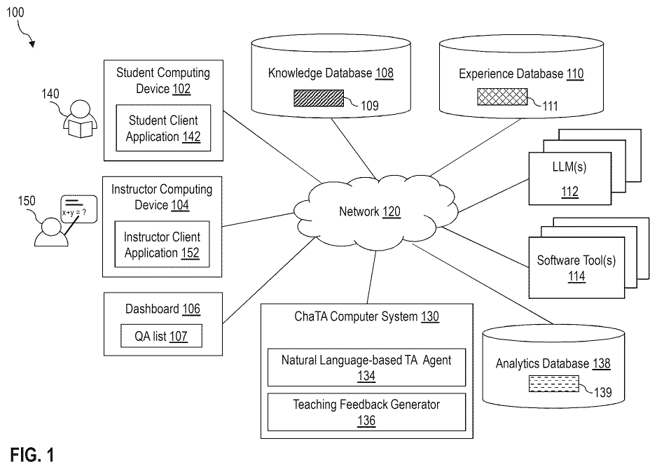

Turning now to FIG. 1, a network system 100 that provides interactive natural language-based teaching assistance to students using LLMs is described. The network system 100 provides an integrated platform including a dashboard 106, a knowledge database 108, an experience database 110, multiple LLMs 112, software tools 114, a network 120, a ChaTA system 130, and an analytics database 138. The network 120 promotes communication between the components of the network system 100. The network 120 may be any communication network including a public data network (PDN), a public switched telephone network (PSTN), a private network, and/or a combination.

The knowledge database 108 may include course-specific and/or instructor-specific course materials 109. The course materials 109 may include, for example, but are not limited to, textbooks, class notes, presentation slides, documents, audio and/or video recordings of lectures or lessons, transcripts of lecture or lesson recordings for a specific course and/or prepared by a specific instructor. In some instances, the knowledge database 108 may also include other information, such as course-specific logistic information. The course-specific logistic information may include, for example, but is not limited to, course enrollment information, course syllabus, professor office hours, homework schedules, quiz schedules, and exam schedules. In an example, the knowledge database 108 may include multiple course-specific knowledge databases. For instance, the knowledge database 108 may include a first database for physics, a second database for calculus, and a third database for engineering drawings. In another example, the knowledge database 108 may include instructor-specific knowledge databases. For instance, the knowledge database 108 may include a first database including course materials 109 prepared and/or taught by professor A, a second database including course materials 109 prepared and/or taught by professor B, and a third database including course materials 109 prepared and/or taught by professor C. In a further example, the knowledge database 108 may include multiple course-specific and instructor-specific knowledge databases. For instance, the knowledge database 108 may include a first database including course materials 109 for physics and prepared and/or taught by professor A, a second database including course materials 109 for physics and prepared and/or taught by professor B, and a third database including course materials 109 for physics and prepared and/or taught by professor C. In other instances, the knowledge database 108 may be a single database storing course materials 109 from different instructors in different portions or sections of the database. In some examples, the knowledge database 108 may include different databases for different faculties (e.g., one for mechanical engineering and another one for electrical engineering). Generally, the knowledge database 108 may include one or more knowledge databases with course materials 109 organized in any suitable format. In some examples, the course materials 109 may be stored in the knowledge database 108 in a vector database format. For instance, each data entry in the knowledge database 108 may be represented as a vector in a multi-dimensional space. The vectors can represent a wide range of information, such as embeddings from text, images, audio recordings, video recordings, etc. A vector database can efficiently store and index multi-dimensional data and allow for efficient search in the multi-dimensional data.

The ChaTA system 130 may include at least one non-transitory memory and at least one processor. The ChaTA system 130 may include a natural language-based TA agent 134 (a ChaTA agent) including instructions stored in the memory and executable by the processor. The natural language-based TA agent 134 may communicate with the student 140 via a student client application 142 executing on a computing device 102 of the student 140 and may communicate with the instructor 150 via an instructor client application 152 executing on a computing device 104 of the instructor 150. For ease of illustration, FIG. 1 illustrates one student 140 and corresponding student computing device 102 and one human instructor 150 and corresponding instructor computing device 104. However, the network system 100 can include any suitable number of students 140 and corresponding student computing devices 102 (e.g., 2, 3, 4, 10, 20, 30, 40, 50, 100 or more) and any suitable number of human instructors 150 and corresponding instructor computing devices 104 (e.g., 2, 3, 4, 5, 6, 7, 8 or more).

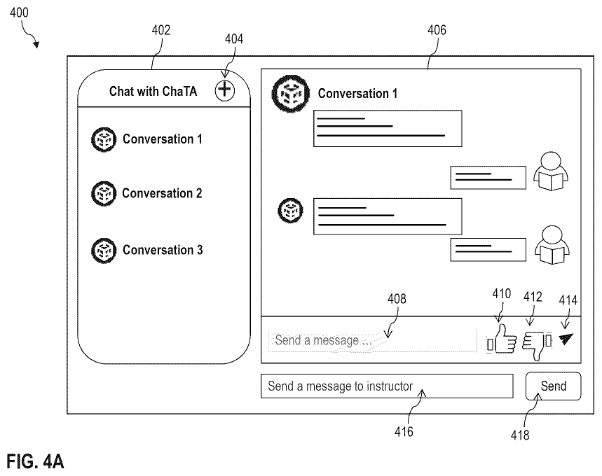

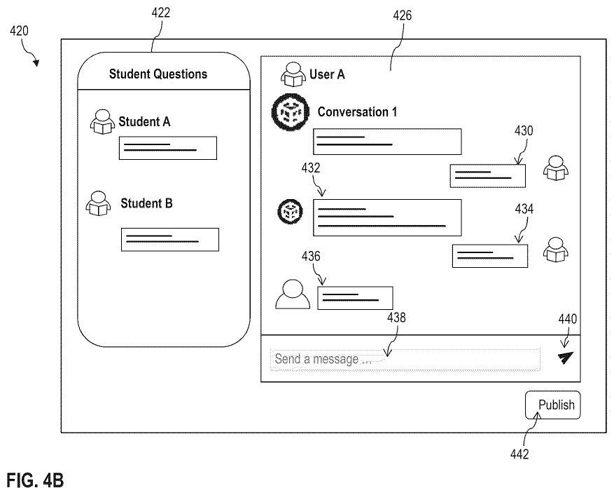

Each of the student computing device 102 and the instructor computing device 104 may be a cell phone, a mobile phone, a smart phone, a smart watch, a personal digital assistant (PDA), a laptop computer, a tablet computer, a notebook computer, a virtual reality headset, or a desktop computer. In some examples, the student client application 142 and/or the instructor client application 152 may render a frontend user interface (UI) with a natural language interface (e.g., the UIs 400 and 420 shown in FIG. 4A-4B), and the natural language-based TA agent 134 may communicate with the front UI via application programming interfaces (APIs). In some examples, the student client application 142 and/or the instructor client application 152 may be web frontend applications, and the natural language-based TA agent 134 may be a web server application. In general, the natural language-based TA agent 134, the student client application 142, and/or the instructor client application 152 may be implemented using any suitable server-client architecture that enables communications among each other.

At a high level, the natural language-based TA agent 134 may communicate with the student client application 142 to receive student queries in natural language from the student 140. The natural language-based TA agent 134 may utilize one or more of the LLMs 112 to generate responses (answers) in natural language to the student queries using the knowledge database 108. The student 140 and/or the human instructor 150 may provide feedback about responses generated by an LLM 112. The student 140 may also request a response from the human instructor 150 upon receiving an unsatisfactory response generated by an LLM 112. The natural language-based TA agent 134 may cache or store a history of student queries and corresponding responses communicated with the student 140 and/or the human instructor 150 in the experience database 110 (as shown by the student query-response data 111).

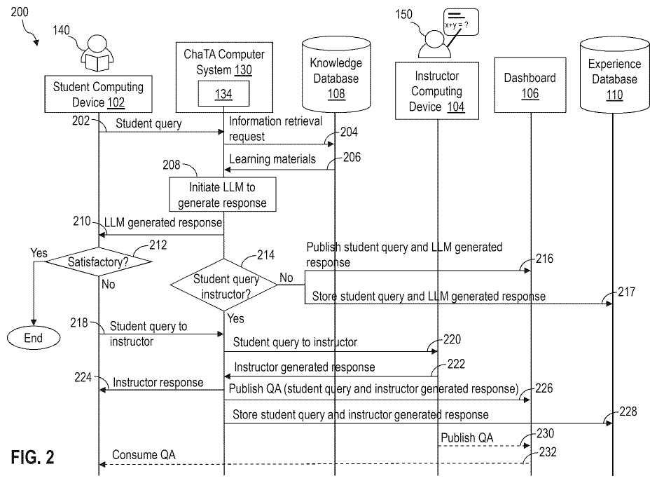

Further, the natural language-based TA agent 134 may publish student queries and corresponding responses (e.g., a list of question-answers (QAs) shown by the QA list 107) in the dashboard 106 to further enhance student learning experience. For instance, the dashboard 106 may be a public dashboard that can be accessed by any student in a class (taught by a certain professor). In some instances, a student may check the dashboard 106 for an answer to a question prior to sending the question to the ChaTA system 130. In an example, the dashboard 106 may be an application executed on a computer system (e.g., similar to the ChaTA system 130). For instance, the dashboard 106 may be a web application executed on a web server with a database that stores the QA list 107, and the student 140 may access the QA list 107 via a web link. The interactions between the components of the network system 100 are described more fully below with reference to FIG. 2.

In an embodiment, the LLMs 112 may be of different LLM types having different attributes. For instance, the LLMs 112 may include, but are not limited to, one or more OpenAI® models (e.g., a GPT-3 model, a GPT-3.5 model, a GPT-4 model), one or more open-source LLMs, an LLM Meta AI (Llama) model, and a Google Gemini® model. The different LLMs 112 may have different performances. For instance, the different LLMs 112 may have different transformer architectures and may be trained on different types of datasets (e.g., from different knowledge fields and in various data modes, such as audio, video, and/or texts) and/or different amounts of data. In an example, a high-performance (or heavy-weight) LLM 112 may be good at answering questions that require deep insights or deep reasoning, a mid-performance (or mid-weight) LLM 112 may be sufficient for answering knowledge (e.g., course-specific) related questions, and a low-performance (or lightweight) LLM 112 may be sufficient for answering general questions.

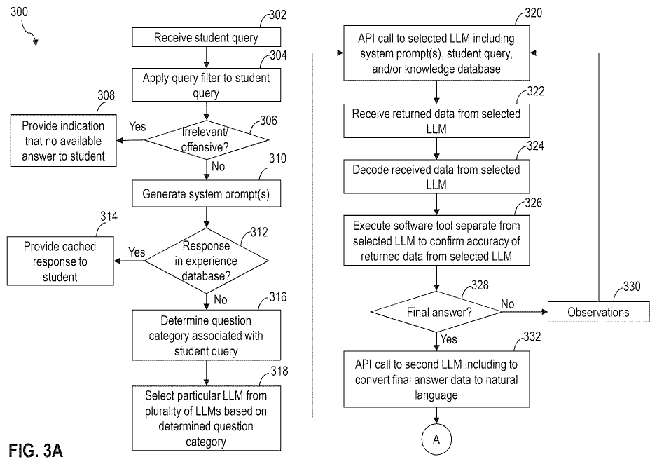

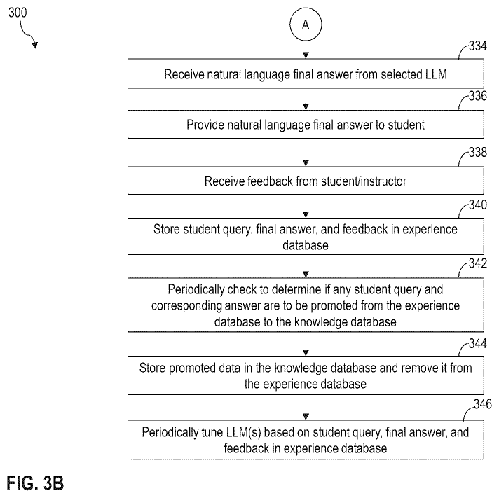

The different LLMs 112 may also have different associated costs. For instance, the different LLMs 112 may utilize different amounts of computational resources and/or memory resources. Additionally or alternatively, the different LLMs 112 may be associated with different subscription or service costs (e.g., each call to an OpenAI LLM incurs a fee). Generally, the higher the performance of the LLM 112, the higher the cost. As will be discussed more fully below with reference to FIGS. 3A and 3B, the natural language-based TA agent 134 may select a particular LLM 112 from the multiple LLMs 112 to answer a student query based on a question type or question category of the student query. Further, at least some of the LLMs 112 may be fine-tuned for operations associated with teaching assistance, such as providing responses to student queries, (e.g., during an initial tuning phase or during an operational phase).

To ensure the accuracy of a response generated by an LLM 112, the natural language-based TA agent 134 may evaluate the LLM generated response using software tools 114 that are independent of (separate from) the respective LLM 112 that generated the response as will be discussed more fully below with reference to FIGS. 3A and 3B. The software tools 114 may include, for example, but are not limited to, mathematical software, software development tools, and/or course-specific software and simulators (e.g., Matlab simulator, Spice circuit simulator, Microsoft Visual Studio, other LLMs, etc.) or web-based systems (e.g., Wolfram Alpha).

To ensure data privacy of the knowledge database 108, the experience database 110, the dashboard 106 may be stored in a private network of an educational institution (e.g., university, college, school), the ChaTA system 130 may be located within the private network, and the LLMs 112 may be executed locally on the ChaTA system 130 or another computer system within the private network.

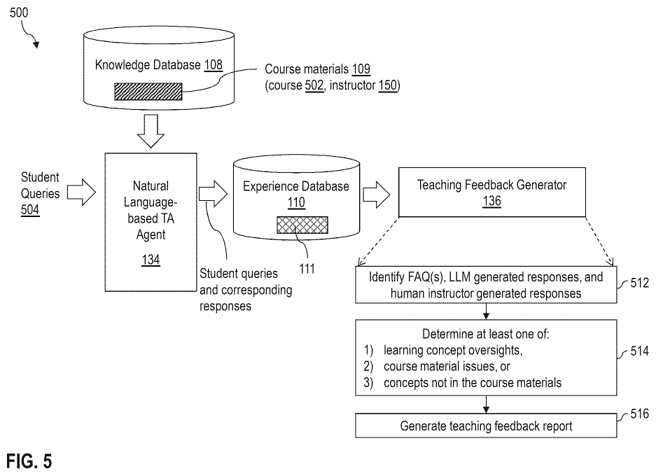

As further shown in FIG. 1, the ChaTA system 130 further includes a teaching feedback generator 136. The teaching feedback generator 136 may include instructions stored in the memory of the ChaTA system 130 and executable by the processor of the ChaTA system 130. The teaching feedback generator 136 may utilize the student query-response data 111 collected from the natural language-based TA agent 134 and stored in the experience database 110 to provide insights into student learning performance and teaching performance. In some instances, the teaching feedback generator 136 may generate analytics data 139 based on the experience database 110 (including student queries and corresponding LLM generated responses and interactions between various students 140 and the human instructor 150). The teaching feedback generator 136 may store the analytics data 139 in the analytics database 138. As will be discussed more fully below with reference to FIGS. 5-6 and 9-10, the teaching feedback generator 136 may generate feedback for a specific instructor (at an individual level), an assessment across multiple instructors teaching the same course (at a group level), and/or an assessment for the same course across faculties (at an institution level).

FIG. 1 is merely an example of components of a network system that provides interactive NLP-based teaching assistance to students and feedback to teachers or instructors, and variations are contemplated to be within the scope of the present disclosure. In embodiments, the network system may include other components not illustrated in FIG. 1. In embodiments, the network system may not include every component illustrated in FIG. 1. In embodiments, the components and connections may be implemented with different connections than those illustrated in FIG. 1. Such and other embodiments are contemplated to be within the scope of the present disclosure.

Turning now to FIG. 2, an example method 200 for providing interactive natural language-based teaching assistance to students is described. The method 200 illustrates operations performed by various components of the network system 100. Specifically, the components include the ChaTA system 130 (or more specifically, the natural language-based TA agent 134), the student 140 and corresponding student computing device 102, the human instructor 150 and corresponding instructor computing device 104, the knowledge database 108, the dashboard 106, and the experience database 110. However, it is contemplated that other component(s) of the network system 100 may be involved in performing the operations of the method 200. As illustrated, FIG. 2 includes a number of enumerated operations, but embodiments of the operations in FIG. 2 may include additional operations before, after, and in between the enumerated operations. In some embodiments, one or more of the enumerated operations may be omitted or performed in a different order.

As shown in FIG. 2, at operation 202, the student 140 transmits, via the student computing device 102, a student query to the natural language-based TA agent 134 at the ChaTA system 130. At operation 204, in response to the student query, the natural language-based TA agent 134 transmits an information retrieval request to the knowledge database 108. At operation 206, the natural language-based TA agent 134 receives course materials 109 (e.g., course-specific and/or instructor-specific course materials that are factual information) from the knowledge database 108. At operation 208, after receiving the course materials 109, the natural language-based TA agent 134 initiates one or more LLMs 112 to generate a response to the student query using the retrieved course materials 109 as will be discussed more fully below with reference to FIGS. 3A-3B. At operation 210, the natural language-based TA agent 134 transmits the LLM generated response to the student computing device 102. In some examples, the LLM generated response may include excerpts of the course materials 109 (e.g., including documents, slides, audio files, and/or video files) that are relevant to the student query. For instance, the student query may ask about a deep learning model, and the LLM generated response may include information and/or examples about deep learning models extracted from the course materials 109.

At operation 212, after receiving the LLM generated response, the student 140 determines whether the LLM generated response is satisfactory or not. If the LLM generated response received at operation 210 is satisfactory, the student 140 may not take another action regarding the student query requested at operation 202 (e.g., may move on to another student query). If, however, the LLM generated response received at operation 210 is unsatisfactory (e.g., the response is incomplete, does not make sense, seems inaccurate, and/or, generally, does not answer the student query), the student 140 may ask the human instructor 150 (e.g., a professor) for an answer to the query. For instance, at operation 218, the student 140 transmits, via the student computing device 102, the student query directing to the human instructor 150.

Generally, the natural language-based TA agent 134 may monitor whether the LLM generated response provided to the student 140 at operation 210 is satisfactory to the student 140 as shown by operation 214. At operation 220, upon receiving the student query directing to the human instructor 150, the natural language-based TA agent 134 forwards the student query to the instructor computing device 104. At operation 222, in response to the student query forwarded to the human instructor 150, the human instructor 150 transmits, to the natural language-based TA agent 134 via the instructor computing device 104, a modified response to the student query. For instance, the human instructor 150 may review the LLM generated response and correct the LLM generated response. At operation 224, upon receiving the modified response from the human instructor 150, the natural language-based TA agent 134 forwards the modified response to the student computing device 102.

As discussed above, the natural language-based TA agent 134 may publish student query and corresponding responses to the dashboard 106 and store a history of student query and corresponding responses in the experience database 110. Returning to operation 214, if the natural language-based TA agent 134 does not receive any student query, from the student 140, directing to the human instructor 150, the natural language-based TA agent system 134 proceeds to operation 216. At operation 216, the natural language-based TA agent 134 publishes the student query and the corresponding LLM generated response in the dashboard 106. Further, at operation 217, the natural language-based TA agent 134 stores the student query in association with the corresponding LLM generated response in the experience database 110. Similarly, at operation 226, after receiving the modified response from the human instructor 150, the natural language-based TA agent 134 publishes the student query in association with the modified response (from the human instructor 150) in the dashboard 106. Further, at operation 228, the natural language-based TA agent 134 stores the student query in association with the corresponding instructor generated response in the experience database 110. Generally, all interactions between students 140 and human instruction(s) 150 may be stored in the experience database 110 for generating analytics to assist human instructor(s) 150 in understanding the needs and/or performance of the students 140 as will be discussed more fully below with reference to FIG. 5.

In some examples, the human instructor 150 may publish FAQs and corresponding answers (related to a certain course) in the dashboard 106 (e.g., at operation 230). The student 140 may consume information published in the dashboard 106 (e.g., at operation 232). In an example, the student 140 may search the dashboard 106 for an answer to a question prior to asking the natural language-based TA agent 134. In some instances, the dashboard 106 may be a public dashboard that can be accessed by any student within a certain department or faculty.

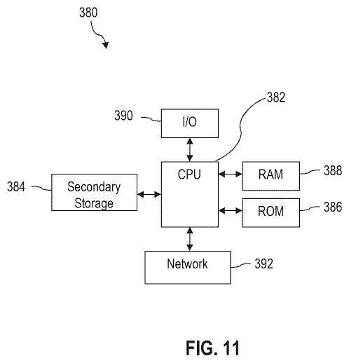

Turning now to FIGS. 3A and 3B, an example method 300 for providing interactive natural language-based teaching assistance to students is described. The method 300 may include similar mechanisms as discussed above with reference to FIGS. 1-2. The method 300 may be implemented by the natural language-based TA agent 134. In embodiments, the method 300 may be implemented using a computer system with components as shown in FIG. 11. As illustrated, FIGS. 3A and 3B include a number of enumerated operations, but embodiments of the operations in FIGS. 3A and 3B may include additional operations before, after, and in between the enumerated operations. In some embodiments, one or more of the enumerated operations may be omitted or performed in a different order.

At block 302, the natural language-based TA agent 134 receives a student query in natural language from the student client application 142 executing on the student computing device 102. At block 304, upon receiving the student query, the natural language-based TA agent 134 applies a query filter to the student query. At block 306, based on the application of the query filter, the natural language-based TA agent 134 determines if the student query is irrelevant and/or offensive. If the student query is irrelevant and/or offensive, the natural language-based TA agent 134 may proceed to block 308. At block 308, the natural language-based TA agent 134 provides a simple response to the student, for example, indicating that the student query cannot be answered. Otherwise, the natural language-based TA agent 134 proceeds to block 310.

At block 310, the natural language-based TA agent 134 generates system prompts based on the student query. As part of generating the system prompts, the natural language-based TA agent 134 may determine a context, a reference to the knowledge database 108, and a reference to the experience database 110 based on the student query. The context may include an indication of a certain subject or course (e.g., a math course, a programming course, an engineering science course, etc.) associated with the student query. In some examples, a school or university may offer multiple classes for the same course but may be taught by different instructors. Thus, the context may also include an indication of a certain instructor associated with the student query. For instance, the natural language-based TA agent 134 may determine that the student 140 is in a class taught by the certain instructor based on account information associated with the student 140. The reference to the knowledge database 108 may be determined based on the context (e.g., the class or course indication).

As discussed above, in some examples, the knowledge database 108 may include multiple course-specific and/or instructor-specific knowledge databases 108, and thus the reference may include an indication (e.g., a storage path or a link) to the corresponding course-specific and/or instructor-specific knowledge database. Similarly, the experience database 110 may be based on the course indication and/or the instructor indication in the context. As discussed above, the experience database 110 may include multiple course-specific and/or instructor-specific experience databases, and thus the reference may include an indication (e.g., a storage path or a link) to the corresponding course-specific and/or instructor-specific experience database. The context may include an output configuration including an example question-response pair and/or an output response form or structure to guide an LLM in generating a final output or final answer to the student query. As an example, a student query may be “Where is the recitation session for this class?”. If the natural language-based TA agent 134 finds the answer to the question in the knowledge database 108 provided by the instructor 150, the natural language-based TA agent 134 may respond with “According to the instructors syllabus which can be found at http// . . . the recitations are on Tuesdays 3:00 to 5:00 PM in Helendefels 205”. If, however, the natural language-based TA agent 134 fails to find the answer in the knowledge database 108, the natural language-based TA agent 134 may respond with “I am sorry. This information is not listed in the syllabus, I will elevate your query to the instructor.” Generally, the natural language-based TA agent 134 may use the specific problem-solving forms and models in the instructor 150's lecture notes (in the knowledge database 108) to answer students 140′ relevant questions.

At block 312, the natural language-based TA agent 134 determines whether there is an available response to the student query in the experience database 110. If there is an available response to the student query stored or cached in the experience database 110, the natural language-based TA agent 134 proceeds to block 314. In some examples, the natural language-based TA agent 134 may utilize an LLM (e.g., a lightweight LLM) to perform the check. At block 314, the natural language-based TA agent 134 provides the cached response to the student 140 (e.g., by transmitting the cached response to the student client application 142). Otherwise, the natural language-based TA agent 134 proceeds to block 316.

At block 316, the natural language-based TA agent 134 determines a question category associated with the student query. In some examples, the natural language-based TA agent 134 may utilize a classifier, an ML model, or an LLM 112 to perform the classification. In an embodiment, student queries may be classified into a general question category, a knowledge question category, or a deep reasoning (or deep insight) question category. The general question category may include queries that are not related to a specific course and do not require information from the knowledge database 108. The knowledge question category may include queries that are related to a specific course and require information (e.g., excerpts of course materials 109) from the knowledge database 108. The deep reasoning question category may include queries that require reasoning rather than simply course-specific knowledge and may or may not require information from the knowledge database 108.

At block 318, the natural language-based TA agent 134 selects a particular LLM 112 from the multiple LLMs 112 based on the determined question category associated with the student query. In an embodiment, the LLMs 112 may include a high-performance LLM 112 (e.g., an OpenAI® GPT-4 or higher version model), a mid-performance LLM 112 (e.g., an open-source LLM with additional RAG), and a low-performance LLM 112 (e.g., a Llama model). If the student query is in the deep reasoning question category, the natural language-based TA agent 134 may select the high-performance LLM 112. If the student query is in the knowledge question category, the natural language-based TA agent 134 may select the mid-performance LLM 112. If the student query is in the general question category, the natural language-based TA agent 134 may select the low-performance LLM 112. Generally, there may be any suitable number of question categories (e.g., 2, 3, 4 or more), each mapped to a different one of the LLMs 112, and the natural language-based TA agent 134 may select the LLM 112 based on the mapping.

At block 320, after selecting the particular LLM 112, the natural language-based TA agent 134 invokes an API call to the selected LLM 112. The natural language-based TA agent 134 may include the system prompts, the student query (the user prompt), and/or relevant information or course materials in the knowledge database 108 in an input to the API call. In some examples, the natural language-based TA agent 134 may include the system prompts and the student query in the input to the API call, for example, when the student query is under the general question category or the deep reasoning category. In some examples, the natural language-based TA agent 134 may include the system prompts, the student query, and the relevant information or course materials 109 (from the knowledge database 108) in the input to the API call, for example, when the student query is under the knowledge question category or the deep reasoning category.

In some examples, the natural language-based TA agent 134 may apply a RAG process to retrieve relevant information from the knowledge database 108 and direct the selected LLM 112 to use the retrieved information for generating the response to the student query. The RAG process may use a similarity measure between the student query and the information in the knowledge database 108 to identify the most relevant information (e.g., the top 10 most relevant information pieces) from the knowledge database 108 to be used for answering the student query. In some examples, the natural language-based TA agent 134 may further apply a ranking process to narrow down the number of information pieces identified from the RAG process. For instance, the ranking process may identify a subset of the information pieces (e.g., the top 5 out of the 10 relevant information pieces) identified from the RAG process, and the selected LLM 112 may use the subset of the information pieces to generate the response to the student query. In some examples, the natural language-based TA agent 134 may utilize ML (e.g., an MMR model) to perform the ranking.

In an example, the system prompts generated at block 310 may be in the form of reasoning and action (ReACT). For instance, the system prompts may include a sequence of one or more thoughts, each followed by an action and an action input. In such an example, the API call at block 320 for initiating the selected LLM 112 to generate a response to the student query may include input arguments including a question (e.g., the student query) and the sequence of one or more thoughts and corresponding actions and action inputs. In an example, the API call may be as shown below:
API call (question, thought, action, action input).

As an example, the student query received at block 302 includes “what is circuit modeling?”. In such an example, the system prompts may include a series of thoughts. For instance, a first thought may be “collect information about basic circuit components,” a second thought may be “collect information about circuit analysis,” a third thought may be “collect information about types of circuit models (e.g., direct current (DC) vs alternate current (AC)), a fourth thought may be “collect information about circuit modelling techniques,” and a fifth thought may be “collect information about circuit simulation software tools”. Each of the thoughts may be followed by an action indicating “to search” and an action input including a reference to certain section(s) or portion(s) of the course materials 109 in the knowledge database 108 (or excerpts of certain section(s) or portion(s) of the course materials 109) that include relevant information related to the respective thought. In general, the system prompts or the sequence of thoughts, actions, and action inputs may guide the selected LLM 112 to think and act autonomously (which may include using external tools) based on the user prompt (the received student query) and the knowledge database 108 (e.g., the relevant portions of the knowledge database 108).

At block 322, in response to the API call at block 320, the natural language-based TA agent 134 receives returned data (e.g., textual data) from the selected LLM 112. At block 324, the natural language-based TA agent 134 may decode the data received from the selected LLM 112. The decoding may include parsing the received text data into a specific format. As an example, the student query may request assistance in understanding a certain concept, the received text data may be a sequence of characters, sub-words, and/or words, and the decoding may format the received data into meaningful sentences. As another example, the student query may request for a piece of JavaScript object notation (JSON) code for performing a certain operation, the received text data may be a sequence of characters, numerical values, sub-words, and/or words, and the decoding may format the received data into the JSON code format. As a further example, the student query may request for a piece of python code that performs a certain operation, the received text data may be a sequence of characters, numerical values, sub-words, and/or words, and the decoding may format the received data into the python code format.

At block 326, the natural language-based TA agent 134 executes one or more software tools 114 that are independent of (separate from) the selected LLM 112 to confirm the accuracy of the data received from the selected LLM 112. For instance, the natural language-based TA agent 134 may determine whether the LLM generated data satisfies one or more criteria based on the execution of the one or more software tools 114.

As an example, the student query may request for a python code example to delete a certain word from a document, and the selected LLM 112 may generate a piece of python code to delete the certain word from a document. The one or more software tools 114 may include a python code simulator/debugger that can execute the piece of python code (generated by the selected LLM 112 and formatted by the decoding at block 324). To test the LLM generated python code, the natural language-based TA agent 134 may provide an input document including the certain word (to be deleted) as an input to the formatted python code, execute the formatted python code in the python code simulator/debugger, and check that an output document generated from the execution does not include the certain word. Stated differently, in such an example, the one or more criteria may include checking that the LLM generated python code can execute without errors and that the output of the python code is as expected. In some instances, the software tools 114 may include another LLM 112 different than the selected LLM 112, and the natural language-based TA agent 134 may use the other LLM 112 to judge the output returned by the selected LLM 112. For instance, the other LLM 112 may determine whether the output returned by the selected LLM 112 is in coherence and compliant with the context provided in the system prompts (generated at block 310).

At block 328, the natural language-based TA agent 134 determines whether the data returned from the selected LLM 112 at block 322 is the final answer based on the execution of the one or more software tools 114. If the natural language-based TA agent 134 determines that the returned data from the selected LLM 112 at block 322 is inaccurate (e.g., failing to satisfy the one or more criteria), the returned data is not the final answer. If the returned data is not the final answer, the natural language-based TA agent 134 proceeds to block 330. At block 330, the natural language-based TA agent 134 makes observations (e.g., errors or inaccuracies, missing information, etc.) based on the evaluation (e.g., the execution of the software tools at block 326) and returns to block 320 to repeat the process of initiating the selected LLM 112 to generate a response to the student query. When repeating this process, the natural language-based TA agent 134 may provide additional feedback observed from the execution of the one or more software tools 114 (at block 328) to the selected LLM 112 in addition to the system prompts and the user prompt that were previously provided to the selected LLM 112. As an example, if a student 140 requests a piece of code for generating the factorial of a number, a request for a factorial of zero or a negative number may not be correct. In this case, the LLM 112 may repeat the process (of generating the factorial) with the additional requirement to include the case of 0 factorial and additionally an error message if a negative number is input to the factorial generation code. As another example, if a student 140 requests an algorithm for a simulation task, the natural language-based TA agent 134 may invoke an additional software tool 114 to run the code to make sure the code is bug-free. In this case, the observation may be the bug information from the additional software tool 114. As a further example, the code for the algorithm may go into an infinite loop if a wrong termination condition is set or if indices are mishandled. The infinite loop information may assist the natural language-based TA agent 134 to revise the final answer. Generally, in each repeating API call to the LLM 112, the natural language-based TA agent 134 may include a previous response or data generated by the selected LLM 112 in the API call input and/or feedback based on observations made by the natural language-based TA agent 134. If, however, the natural language-based TA agent 134 determines that the LLM generated response is accurate (e.g., satisfying the one or more criteria), the data returned from the selected LLM 112 at block 322 is the final answer. Accordingly, the natural language-based TA agent 134 proceeds to block 332.

At block 332, the natural language-based TA agent 134 may initiate a second LLM 112 to generate a final answer in natural language to the student query. In some examples, the second LLM 112 may be the same as the selected LLM 112. In other examples, the second LLM 112 may be different than the selected LLM 112. At block 334, the natural language-based TA agent 134 may receive the final answer from the selected LLM 112. At block 336, upon receiving the final answer, the natural language-based TA agent 134 may provide the final answer to the student 140 by transmitting the final answer to the student client application 142.

At block 338, the natural language-based TA agent 134 receives feedback from the student 140 (via the student computing device 102) and/or the human instructor 150 (via instructor computing device 104). In an example, the student 140 may provide a thumbs up indicator or a thumbs down indicator to indicate whether the final answer provided by the natural language-based TA agent 134 is satisfactory or unsatisfactory, respectively. Similarly, the human instructor 150 may review the final answer (provided by the natural language-based TA agent 134) and provide a thumbs up indicator or a thumbs down indicator to indicate whether the final answer is satisfactory or unsatisfactory, respectively. Other forms of feedback may additionally and/or alternatively be provided by the student 140 and/or human instructor 150.

At block 340, the natural language-based TA agent 134 stores the student query, the final answer, and the received feedback in the experience database 110. In general, the natural language-based TA agent 134 may store the entire conversation with the student 140 and/or the human instructor 150 in the experience database 110. As discussed above with reference to FIG. 2, in some instances, the student 140 may query the human instructor 150 when the response provided by the natural language-based TA agent 134 (or more specifically, by the selected LLM 112) is unsatisfactory. In such instances, the natural language-based TA agent 134 may store the response provided by the human instructor 150 in the experience database 110 instead of the LLM generated response.

At block 342, the natural language-based TA agent 134 periodically (e.g., hourly, daily, biweekly, or monthly) determines if any student query and corresponding answer are to be promoted from the experience database 110 to the knowledge database 108. For instance, the natural language-based TA agent 134 may determine to promote a certain student query and corresponding answer based on the answer being a “golden answer” provided by the human instructor 150 or a reception of positive feedback from the human instructor 150. At block 344, the natural language-based TA agent 134 stores the promoted data (e.g., a student query and a corresponding answer) in the knowledge database 108. After promoting the data to the knowledge database 108, the natural language-based TA agent 134 may remove the promoted data from the experience database 110. Generally, the natural language-based TA agent 134 may promote student queries and corresponding responses from the experience database 110 to the knowledge database 108 at any suitable time.

At block 346, the natural language-based TA agent 134 periodically (e.g., hourly, daily, biweekly, or monthly) tunes parameters of the one or more of the LLMs 112 based on the student queries and corresponding responses and/or feedback. Generally, an LLM 112 may include various types of parameters, such as embedding parameters and transformer parameters. The embedding parameters (which may be referred to as embeddings) are used to map words or tokens into continuous vector representations. Each word or token in the model's vocabulary is associated with a unique embedding vector. These embeddings capture semantic relationships between words, allowing the model to understand the meaning and context of the text. The LLM 112 may have a transformer architecture including a plurality of self-attention layers and feedforward neural networks. The transformer parameters may include attention parameters, feedforward parameters, output parameters, positional encoding parameters, and normalization parameters. The attention parameters may determine how much importance the LLM 112 may give to each word or token in the input sequence when processing a given word or token. The feedforward parameters are parameters in each transformation layer of the feedforward neural networks. The output parameters are used to generate the final output of the LLM 112, which may be a probability distribution over the vocabulary. The output parameters are learned based on the context provided by the input text and are used to predict the next word or token in a sequence. The positional encoding parameters are used to provide information about the position of words in the input sequence and may assist the LLM 112 to maintain the sequential order of words during processing. The normalization parameters are used to normalize the activations of neurons in each transformer layer, ensuring that the model learns effectively. In an example, parameters of an LLM 112 may be trained or fine-tuned based on a student query and a response provided or corrected by the human instructor 150. In another example, the parameters of an LLM 112 may be trained or fine-tuned based on a student query, a response generated by the LLM 112, and feedback from the student 140. In some examples, the tuning or training may apply different weights (or rewards) depending on whether the feedback is from the student 140 or the human instructor 150. Generally, the natural language-based TA agent 134 may tune parameters of the one or more LLMs 112 at any suitable time.

Generally, the operations of the method 300 may be implemented in any suitable way. In some examples, the natural language-based TA agent 134 may include multiple software modules, for example, including a preprocessor, system prompt generator, a router, and a natural language-based TA agent (“ChaTA agent”). In such examples, the operations at blocks 302 to 308 may be performed by the preprocessor, the operations at block 310 may be performed by the system prompt generator, the operations at blocks 316 to 318 may be performed by the router, and the operations at blocks 320 to 346 may be performed by the ChaTA agent.

Turning now to FIG. 4A, an example UI 400 is described. In an embodiment, the UI 400 may be rendered by the student client application 142 and communicate with the natural language-based TA agent 134 (e.g., via APIs,). For instance, the student 140 may execute the student client application 142 on the student computing device 102 and may communicate with the natural language-based TA agent 134 using the UI 400.

As shown in FIG. 4A, the UI 400 may include a left panel 402 and a right panel 406. The left panel 402 may indicate conversation threads (shown by Conversation 1, Conversation 2, and Conversation 3) between the student 140 and the natural language-based TA agent 134. The left panel 402 may also include an interface 404 that the student 140 may click to start another conversation thread (e.g., conversation 4). The top portion of the right panel 406 may include a display of a current conversation (e.g., conversation 1) between the student 140 (on the right side) and the virtual, intelligent TA provided by the natural language-based TA agent 134 (on the left side). The middle portion of the right panel 406 may include a text box 408, a thumbs up indicator 410, a thumbs down indicator 412, and an interface 414. The student 140 may enter a query in the text box 408 and send the query to the natural language-based TA agent 134 by clicking the interface 414. The student 140 may also provide feedback to a response provided by the natural language-based TA agent 134 by clicking the thumbs up indicator 410 to indicate that the response is satisfactory or the thumbs down indicator 412 to indicate that the response is unsatisfactory. The bottom portion of the right panel 406 may include a text box 416 and a button 418. The student 140 may enter a query directing to the human instructor 150 in the text box 416 and may click the interface 414 to send the query to the human instructor 150 (e.g., when the student 140 is unsatisfied with a response returned by the natural language-based TA agent 134).

Turning now to FIG. 4B, an example UI 420 is described. In an embodiment, the UI 420 may be rendered by the instructor client application 152 and communicate with the natural language-based TA agent 134 (e.g., via APIs,). For instance, a human instructor 150 may execute the instructor client application 152 on the instructor computing device 104 and may communicate with the natural language-based TA agent 134 using the UI 420. The UI 420 may operate in relation to the UI 400. That is, the instructor 140 interacts with the natural language-based TA agent 134 via the UI 420 while a student 140 interacts with the natural language-based TA agent 134 via the UI 400.

As shown in FIG. 4B, the UI 420 may include a left panel 422 and a right panel 426. The left panel 422 may show questions from the students 140 (e.g., a student A and a student B). Generally, the UI 420 may indicate a student 140 using any suitable identification (e.g., by names, student identification numbers, student login identifiers, etc.). The right panel 426 may show conversations between the students 140 and the natural language-based TA agent 134 (e.g., as shown by the conversations thread in the panel 406 of FIG. 4A). In the illustrated example of FIG. 4B, the right panel 426 shows conversations between a particular student 140 A and the natural language-based TA agent 134. As shown, the student 140 A may ask a question 430, and the natural language-based TA agent 134 may send a response 432 to the question 430 (using mechanisms discussed above with reference to FIGS. 1-2 and 3A-3B). As an example, the student 140 A may not understand (or may be unsatisfied with) the response 432 provided by the natural language-based TA agent 134, and thus may direct the question 430 to the instructor 150. The instructor 150 may respond by providing an explanation through the response 436. The instructor 150 may enter the response 436 in the text box 438 and may click the interface 440 to send the response 436. In some instances, when the instructor 150 may determine that a certain student 140's question may be a common question among students 140 in a class, the instructor 150 may also publish the student 140's question and a corresponding response (e.g., from the instructor 150 or the natural language-based TA agent 134) to the whole class (e.g., via the dashboard 106) by clicking the interface 442.

FIGS. 4A-4B are merely an example of components of a UI, and variations are contemplated to be within the scope of the present disclosure. In embodiments, the UI may include other components not illustrated in FIGS. 4A-4B. In embodiments, the UI may not include every component illustrated in FIGS. 4A-4B. In embodiments, the components of the UI may be arranged differently than those illustrated in FIGS. 4A-4B. Such and other embodiments are contemplated to be within the scope of the present disclosure.

Turning now to FIG. 5, an example method 500 for providing teaching feedback for an individual instructor is described. The method 500 utilizes the student query-response data 111 collected from the natural language-based TA agent 134 to generate teaching feedback for a specific instructor 150. As shown in FIG. 5, the natural language-based TA agent 134 receives a plurality of student queries 504 associated with a course 502, for example, from one or more students 140 taught by the specific instructor 150. The natural language-based TA agent 134 may respond to the student queries 504 using the methods 200 and 300 discussed above with reference to FIGS. 2 and 3A-3B, respectively. For instance, the natural language-based TA agent 134 may respond to the student queries 504 using LLM(s) 112 and the knowledge database 108 (or more specifically, the course materials 109 prepared by the specific instructor 150 for the course 502). The natural language-based TA agent 134 may also request responses from the specific instructor 150 (e.g., when an LLM generated response is determined to be unsatisfactory by a respective student 140). The natural language-based TA agent 134 may also output and store student queries 504 in association with corresponding responses (e.g., including LLM generated responses and/or human instructor generated responses) as student query-response data 111 in the experience database 110.

The teaching feedback generator 136 may retrieve and process the student query-response data 111 collected in the experience database 110 to generate a teaching feedback report for the specific instructor 150. For instance, at block 512, the teaching feedback generator 136 identifies, from the student query-response data 111, a list of FAQs, LLM generated responses (generated by the LLM(s) 112), and human instructor generated responses (generated by the specific instructor 150). In an example, the teaching feedback generator 136 may identify the list of FAQs from the student query-response data 111 based on a number of occurrences of certain student queries 504 related to a certain learning concept in the student query-response data 111 is high (e.g., meeting a certain threshold). Alternatively, the teaching feedback generator 136 may select the top X (e.g., 5, 10, 20, 30 or more) number of highest occurrences student queries 504 as FAQs.

At block 514, the teaching feedback generator 136 determines, based on the FAQs, the LLM generated responses, and the human instructor generated responses, at least one of learning concept oversights (e.g., concepts in which students 140 may have difficulties in learning), issues with the course materials 109, or core problems that are not in the course materials 109. In an example, the teaching feedback generator 136 may determine learning concepts oversights based on the FAQs. For instance, the teaching feedback generator 136 may classify (e.g., using a classifier, a ML model, or an LLM) the student queries 504 (in the student query-response data 111) into categories of various learning concepts corresponding to learning goals for the specific course 502. The learning concepts covered by the FAQs may indicate learning concepts that the students 140 may have difficulties in learning.

In another example, the teaching feedback generator 136 may identify, for each LLM generated response (retrieved from the student query-response data 111), a corresponding portion of the course materials 109 from the knowledge database 108. The teaching feedback generator 136 may classify (e.g., using a classifier, a ML model, or an LLM) each of the identified portions of course materials 109 into one of the learning concepts. The learning concepts covered by the identified portions of course materials 109 (used for generating the responses to the student queries 504) may indicate learning concepts that the students 140 may have difficulties in learning. The learning concepts covered by the identified portions of course materials 109 may also indicate issues in the course materials 109. For instance, the teaching feedback generator 136 may analyze the content, the language, and/or the presentation style in the identified portions of course materials 109 (e.g., using ML or LLMs) to determine the reasons for having a large number of student queries 504 directed to those portions of the course materials 109.

In yet another example, the teaching feedback generator 136 may determine issues in the course materials 109 and/or core problems or learning concepts that are not in the course materials 109 based on the human instructor generated responses (retrieved from the student query-response data 111). For instance, the teaching feedback generator 136 may compare the human instructor generated responses to information provided in the course materials 109 (e.g., using semantic searches, ML, and/or LLMs). In one example, the feedback generator 136 may determine that the course materials 109 provide different or contradicting information compared to the respective human instructor generated response. In another example, the feedback generator 136 may determine, based on the comparison, that course materials 109 do not cover certain knowledge information provided by the respective human instructor generated response. In some other instances, the teaching feedback generator may determine an issue in a certain portion or a certain concept of the course materials when there is a high number of student queries (e.g., greater than a certain threshold) directing to that portion or concept.

At block 516, the teaching feedback generator 136 generates a teaching feedback report including the learning concept oversights, the course material issues, and/or the core problems not in the course materials 109 determined at block 514. Subsequently, the teaching feedback generator 136 may provide the teaching feedback report to the specific instructor 150 (e.g., via instructor client application 152 or any other suitable forms of communications). In some examples, the teaching feedback generator 136 may provide the teaching feedback report to the specific instructor 150 based on a request from the specific instructor 150. In some examples, the teaching feedback generator 136 may provide the teaching feedback report to the specific instructor 150 based on a certain schedule (e.g., weekly, monthly, etc.). In this way, the specific instructor 150 may adjust the course materials 109 to cover missing concepts and/or correct issues and/or teachings in class to focus on concepts that the students 140 have difficulties in learning.

In some examples, the teaching feedback generator 136 may generate analytics data 139 based on the experience database 110 (including student queries and corresponding LLM generated responses and interactions between various students 140 and the human instructor 150), and the teaching feedback report may be based on the analytics data 139. The analytics data 139 may include a variety of information related to class management and student data analytics. For instance, the analytics data 139 may include student overall performance by topics or learning concepts (e.g., based on the number of questions asked by the students for corresponding topics). In an example, quizzes, tests, and/or exams may be generated based on the course materials 109, and scores or results of the students 140 may be collected for analysis. Additionally or alternatively, the analytics data 139 may include student engagement analytics (e.g., based on the number of questions asked by the students and/or the number of ratings from the students for corresponding topics). Additionally or alternatively, the analytics data 139 may include identification of at-risk students 140. For instance, an at-risk student 140 may ask a large amount of questions related to a certain topic and/or have a poor performance in quizzes, tests, and/or exams. Identifying at-risk students 140 may allow the human instructor 150 to reach out to those students 140 or add additional classes to assist those students 140. Additionally or alternatively, the analytics data 139 may include teaching adjustment recommendations and feedback (e.g., based on issues and/or teaching effectiveness of the course materials 109 identified as discussed).

In an embodiment, the analytics data 139 related to the student overall performance by topics or learning concepts may be presented in a report format. For instance, the report may include, for each topic, an average score (e.g., in percentage (%)), a standard deviation, the percentage of students receiving a score below a certain threshold (e.g., 70%), and a summary of most common issues experienced (or mistakes made) by the students 140. Some examples of most common issues may be confusion over certain topics, misapplication of certain equations or concepts, errors in specific calculations, etc.

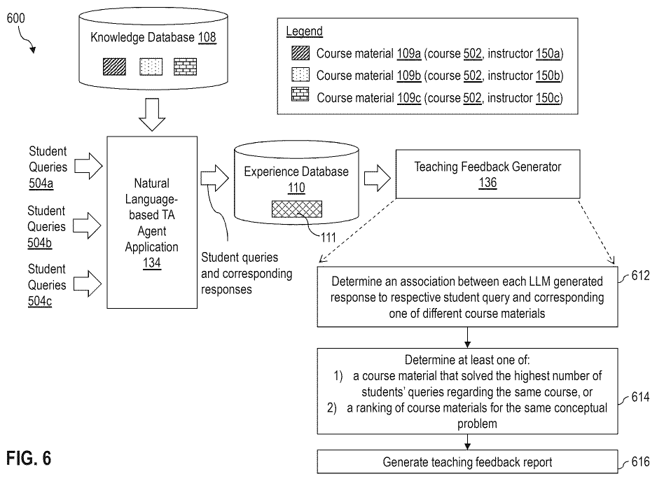

Turning now to FIG. 6, an example method 600 for providing teaching feedback across multiple instructors teaching the same course is described. The method 600 utilizes the student query-response data 111 collected from the natural language-based TA agent 134 to generate teaching feedback or an assessment across multiple instructors 150 teaching the same course 502. For ease of illustrations, FIG. 6 illustrates three instructors 150a, 150b, and 150c. However, the method 600 can be used to provide teaching feedback across any suitable number of instructors (e.g., 2, 3, 4 or more) teaching the same course 502.

As shown in FIG. 6, the natural language-based TA agent 134 receives a plurality of student queries 504a, 504b, and 504c associated with the same course 502. The student queries 504a may be received from students 140 in a class taught by the instructor 150a. The student queries 504b may be received from students 140 in a class taught by the instructor 150b. The student queries 504c may be received from students 140 in a class taught by the instructor 150c. The natural language-based TA agent 134 may respond to the student queries 504a, 504b, and 504c using the methods 200 and 300 discussed above with reference to FIGS. 2 and 3A-3B, respectively. For instance, the natural language-based TA agent 134 may respond to each of the student queries 504a, 504b, or 504c by initiating LLM(s) 112 to generate corresponding responses using the course materials 109 prepared by the respective instructor 150. That is, the natural language-based TA agent 134 may respond to the student queries 504a by initiating LLM(s) 112 to generate corresponding responses using the course materials 109a prepared by the instructor 150a, and so on.

The natural language-based TA agent 134 may also request responses from the instructors 150a, 150b, and/or 150c. For instance, when an LLM generated response to a student query 504a is determined to be unsatisfactory by a respective student 140, the natural language-based TA agent 134 may transmit the student query 504a to the instructor 150a. Similarly, when an LLM generated response to a student query 504b is determined to be unsatisfactory by a respective student 140, the natural language-based TA agent 134 may transmit the student query 504a to the instructor 150b, and so on.

The natural language-based TA agent 134 may also output and store student queries 504 in association with corresponding responses (e.g., including LLM generated responses and/or human instructor generated response) as student query-response data 111 in the experience database 110. In some instances, the natural language-based TA agent 134 may store student queries 504 and corresponding responses associated with different instructors 150 in different sub-databases within the experience database 110. In general, the natural language-based TA agent 134 may organize the student queries 504 and corresponding responses in any suitable arrangement.

The teaching feedback generator 136 may retrieve and process the student query-response data 111 collected in the experience database 110 to generate a teaching report providing an assessment across the different instructors 150 (or more specifically across the different course materials 109 provided by the different instructors 150). For instance, at block 612, the teaching feedback generator 136 determines an association between each LLM generated response (retrieved from the student query-response data 111) to respective student queries 504 and corresponding one of the different course materials 109 (e.g., using ML and/or LLMs). For instance, an LLM generated response to a student query 504a may include wordings and/or information from the course materials 109a because the natural language-based TA agent 134 may have instructed an LLM 112 to generate the response using the course materials 109a based on the student query 504a associated with the instructor 150a.

At block 614, the teaching feedback generator 136 determines, based on the association, a course material 109 that solved the highest number of student queries 504 regarding the same course 502 and/or a ranking of the course materials 109a-c for the same conceptual problem. As an example, the teaching feedback generator 136 may determine that 100 LLM generated responses are based on the course materials 109a, 200 LLM generated responses are based on the course materials 109b, and 300 LLM generated responses are based on the course materials 109c. Thus, the course materials 109c may have solved the highest number of student queries 504.

As another example, the teaching feedback generator 136 may determine which of the course materials 109 are better or more effective in teaching a certain learning concept. For instance, the teaching feedback generator 136 may compare a number of the LLM generated responses associated with a portion of the course materials 109a (prepared by the instructor 150a) that teaches a particular learning concept to a number of the LLM generated responses associated with a portion of the course materials 109b (prepared by the instructor 150b) that teaches the same particular learning concept. The teaching feedback generator 136 may determine that the course materials 109 associated with the smaller number of LLM generated responses may be more effective in teaching the certain learning concept as less student queries 504 related to that course materials 109 are received. As an example, the teaching feedback generator 136 may determine that the first instructor 150's answer may be more effective based on fewer students 140 asking questions related to the first course material 109 or that the students 140 give a higher rating to the answers provided by the first instructor 150. As part of comparing the effectiveness of the different course materials 109a and 109b, the teaching feedback generator 136 may further determine a difference in instructional styles (e.g., via textual, visual diagrams, problem solving examples, etc.) between the portion of the course materials 109a (associated with the particular learning concept) and the portion of the course materials 109b (associated with the particular learning concept). The teaching feedback generator 136 may further determine a difference in content (e.g., the actual learning information) between the portion of the course materials 109a (associated with the particular learning concept) and the portion of the course materials 109b (associated with the particular learning concept). In some instances, for each course, there may be corresponding exercises, quizzes, and information collected by the natural language-based TA agent 134. As such, the teaching feedback generator 136 can collect comprehensive student data by topics or concepts. Thus, the teaching feedback generator 136 may have statistics of the students 140′ overall performance by topics. For instance, if the performance of the students 140 being taught using a certain course material 109 is higher than another course material 109, that certain course material 109 is better (more effective in teaching). Additionally, the students 140′ engagements may be another indicator (e.g., based on the number of queries and feedback collected by the natural language-based TA agent 134). Generally, the teaching feedback generator 136 may use a variety of metrics to determine the effectiveness of course materials 109. The metrics may include, for example, but are not limited to, students 140′ average performance (e.g., quiz scores) by different course materials 109, students 140′ engagement analytics, student conversational information (e.g., the number of questions related to the same topic or concept), and student feedback (or satisfaction indications).

At block 616, the teaching feedback generator generates a teaching report including an indication of the course material 109 that solved the highest number of student queries 504 regarding the same course 502 and/or the ranking of the course materials 109 for the same conceptual problem determined at block 614. In some higher-level education scenarios, the same course 502 (e.g., mathematics) may be taught in different classes offered by different faculties (e.g., an electrical engineering faculty and a general science faculty). For instance, the course materials 109a may be associated with a first faculty, and the course materials 109b may be associated with a second faculty different than the first faculty. Thus, the teaching feedback generator 136 may also provide an assessment of student learning performance and/or teaching performance for the same course 502 across faculties.

As discussed above with reference to FIGS. 3A-3B, student query and corresponding response may be promoted from the experience database 110 to the knowledge database 108 and may subsequently be removed from the experience database 110. To enable teaching feedback generation as discussed above in the methods 500 and 600, promoted student query-response may be marked as promoted in the experience database 110 without deletion from the experience database 110. Alternatively, the ChaTA system 130 may store student query-response data 111 in an additional database without data promotion.

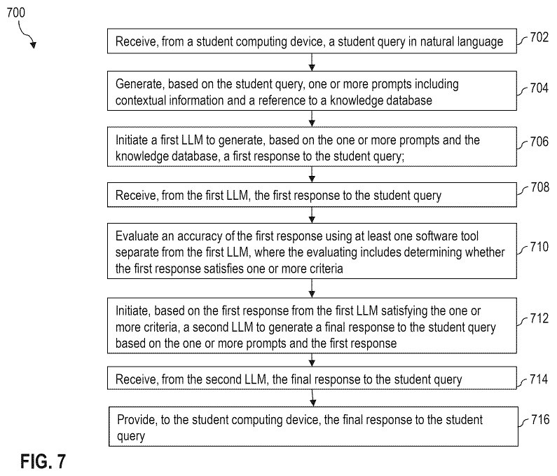

Turning now to FIG. 7, an example method 700 is described. In an embodiment, the method 700 is a method for providing interactive natural language-based, course-specific teaching assistance to students using one or more LLMs with LLM output accuracy evaluation. The method 700 may include similar mechanisms as discussed above with reference to FIGS. 1-2, 3A-3B, and 4A-4B. The method 700 may be implemented by the natural language-based TA agent 134. In embodiments, the method 700 may be implemented using a computer system with components as shown in FIG. 11. As illustrated, FIG. 7 includes a number of enumerated operations, but embodiments of the operations in FIG. 7 may include additional operations before, after, and in between the enumerated operations. In some embodiments, one or more of the enumerated operations may be omitted or performed in a different order.

At block 702, the natural language-based TA agent 134 receives a student query 504 in natural language from a student computing device 102.

At block 704, the natural language-based TA agent 134 generates, based on the student query 504, one or more prompts. The one or more prompts include contextual information associated with the student query 504 and a reference to a knowledge database 108 comprising course materials 109 for a specific course 502 associated with the student query 504. In an embodiment, the course materials 109 for the specific course 502 in the knowledge database 108 includes at least one of an instructor-led lecture recording, a transcript of an instructor-led lecture recording, instructor-specific notes, a textbook, an instructor-specific document, an instructor-specific presentation, or instructor-specific question-answer pair.

At block 706, the natural language-based TA agent 134 initiates a first LLM 112 to generate, based on the one or more prompts and the knowledge database 108, a first response to the student query 504.

At block 708, the natural language-based TA agent 134 receives, from the first LLM 112, the first response to the student query 504.

At block 710, the natural language-based TA agent 134 evaluates an accuracy of the first response using at least one software tool 114 separate from the first LLM 112. The evaluation includes determining whether the first response satisfies one or more criteria.

At block 712, the natural language-based TA agent 134 initiates, based on the first response from the first LLM satisfying the one or more criteria, a second LLM 112 to generate a final response in natural language based on the one or more prompts and the first response from the first LLM 112. In some examples, the first LLM 112 and the second LLM 112 correspond to the same LLM. In other examples, the first LLM 112 may be different than the second LLM 112.

At block 714, the natural language-based TA agent 134 receives, from the second LLM 112, the final response to the student query 504.

At block 716, the natural language-based TA agent 134 provides, to the student computing device 102, the final response to the student query 504.

In an embodiment, the natural language-based TA agent 134 further applies a filter to the student query 504 to eliminate a question unassociated with a learning concept of the specific course (e.g., prior to generating the one or more prompts at block 704). In some instances, the filtering may eliminate at least one of an irrelevant question or an offensive question. In an embodiment, the natural language-based TA agent 134 further identifies, from the course materials 109 in the knowledge database 108, a plurality of course material pieces relevant to the student query based on a RAG process and selects a subset of the plurality of course material pieces based on a ranking process. In such an embodiment, the first response received from the first LLM 112 at block 708 is further based on the selected subset of the plurality of course material pieces. In an embodiment, the initiating the first LLM 112 to generate the first response to the student query 504 is further based on a determination that a previous response from the first LLM 112 fails to satisfy the one or more criteria and an observation (e.g., errors or inaccuracies, missing information, etc.) made from the previous response based on an evaluation of the previous response (e.g., as discussed above with reference to FIGS. 3A-3B).

In an embodiment, the one or more prompts generated at block 704 further includes a guardrail to limit an output of the first LLM 112 to be within a scope of the specific course 502. The guardrail can be a policy or a set of rules (e.g., “The model should not generate violent content,” “The model should generate responses using only the knowledge database 108,” and/or “The model should not generate responses outside the learning concepts for the course 502”). In an embodiment, the one or more prompts generated at block 704 further includes at least one of an example question-response pair or an output response format, and the final response received at block 714 is generated by the second LLM 112 based on the at least one of the example question-response pair or the output response format.

In an embodiment, the natural language-based TA agent 134 further stores the student query 504 received at block 702 and the corresponding final response received from the second LLM 112 at block 714 in an experience database 110. In an embodiment, the initiating the first LLM 112 to generate the first response to the student query 504 is further based on a determination that there is a lack of an available response to the student query 504 in the experience database 110. In an embodiment, the natural language-based TA agent 134 further generates and publishes a question-answer (QA) list including the student query 504 and the corresponding final response in a dashboard 106.

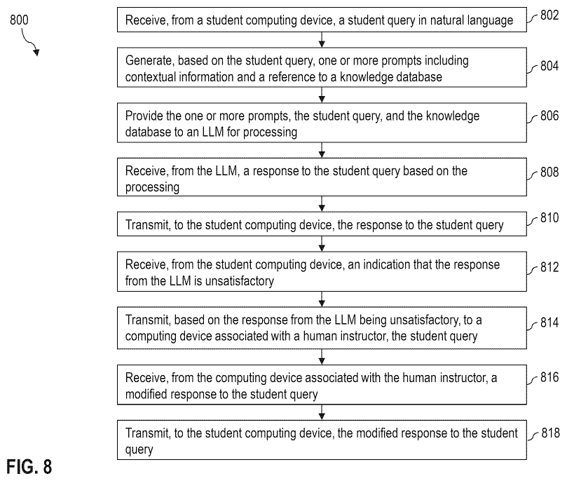

Turning now to FIG. 8, an example method 800 is described. In an embodiment, the method 800 is a method for providing interactive natural language-based, course-specific teaching assistance to students using artificial intelligence with reinforcement learning from human instructor feedback. The method 800 may include similar mechanisms as discussed above with reference to FIGS. 1-2, 3A-3B, 4A-4B, and 7. The method 800 may be implemented by the natural language-based TA agent 134. In embodiments, the method 800 may be implemented using a computer system with components as shown in FIG. 11. As illustrated, FIG. 8 includes a number of enumerated operations, but embodiments of the operations in FIG. 8 may include additional operations before, after, and in between the enumerated operations. In some embodiments, one or more of the enumerated operations may be omitted or performed in a different order.

At block 802, the natural language-based TA agent 134 receives a student query 504 in natural language from a student computing device 102.

At block 804, the natural language-based TA agent 134 generates prompts based on the student query 504. The prompts include contextual information associated with the student query 504 and a reference to a knowledge database 108 including knowledge information associated with a specific course 502.

At block 806, the natural language-based TA agent 134 provides the prompts, the student query 504, and the knowledge database 108 as an input to an LLM 112 for processing.

At block 808, the natural language-based TA agent 134 receives, from the LLM 112, a response to the student query 504 based on the processing.

At block 810, the natural language-based TA agent 134 transmits, to the student computing device 102, the response to the student query 504.

At block 812, the natural language-based TA agent 134 receives, from the student computing device 102, an indication that the response from the LLM 112 is unsatisfactory. In an embodiment, the indication includes the student query 504 directing to the human instructor 150.

At block 814, the natural language-based TA agent 134 transmits, based on the response from the LLM 112 being unsatisfactory, the student query 504 to a computing device 104 associated with a human instructor 150.

At block 816, the natural language-based TA agent 134 receives, from the student computing device 102 associated with the human instructor 150, a modified response to the student query 504.

At block 818, the natural language-based TA agent 134 transmits the modified response to the student computing device 102.

In an embodiment, the natural language-based TA agent 134 further updates one or more parameters of the LLM 112 based on the modified response from the human instructor 150. In an embodiment, the natural language-based TA agent 134 stores the student query 504 and the modified response from the human instructor 150 in an experience database 110 instead of the response from the LLM 112 based on the response from the LLM 112 being unsatisfactory. In an embodiment, the natural language-based TA agent 134 promotes the student query 504 and the modified response from the experience database 110 to the knowledge database 108, where the promoting is based on the modified response being a golden answer received from the human instructor 150. In an embodiment, the natural language-based TA agent 134 further generates and publishes a QA list based at least in part on the student query 504 (received at block 802) and the modified response from the human instructor 150 (received at block 816) in a dashboard 106.

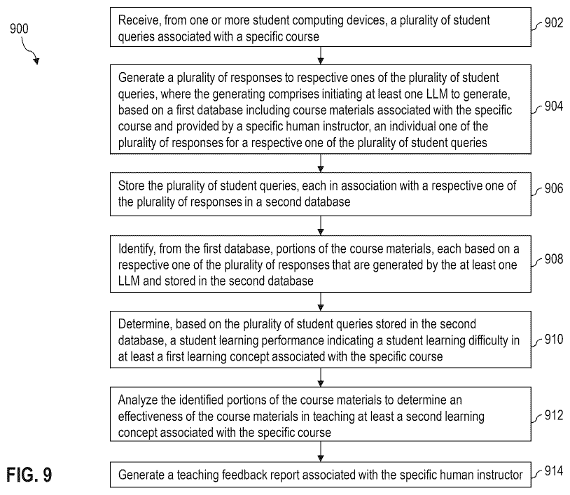

Turning now to FIG. 9, an example method 900 is described. In an embodiment, the method 900 is a method for providing teaching feedback to an individual human instructor. The method 900 may include similar mechanisms as discussed above with reference to FIGS. 1-2, 3A-3B, 4A-4B, 5, and 7-8. The method 900 may be implemented by the natural language-based TA agent 134 and the teaching feedback generator 136. In embodiments, the method 900 may be implemented using a computer system with components as shown in FIG. 11. As illustrated, FIG. 9 includes a number of enumerated operations, but embodiments of the operations in FIG. 9 may include additional operations before, after, and in between the enumerated operations. In some embodiments, one or more of the enumerated operations may be omitted or performed in a different order.

At block 902, the natural language-based TA agent 134 receives, from one or more student computing devices 102, a plurality of student queries 504 associated with a specific course 502. In some instances, the plurality of student queries 504 are associated with an individual student 140. In other instances, the plurality of student queries 504 are associated with a plurality of students 140 (e.g., associated with a certain class).

At block 904, the natural language-based TA agent 134 generates a plurality of responses to respective ones of the plurality of student queries 504. As part of generating the plurality of responses, the natural language-based TA agent 134 initiates at least one LLM 112 to generate, based on a first database (e.g., the knowledge database 108) including course materials 109 associated with the specific course 502 and provided by a specific human instructor 150, an individual one of the plurality of responses for a respective one of the plurality of student queries 504. In an embodiment, the course materials 109 for the specific course 502 in the first database includes at least one of a lecture recording, a transcript of a lecture recording, lecture notes, a textbook, lecture slides, question-answer pairs provided by the specific human instructor 150.

At block 906, the natural language-based TA agent 134 stores the plurality of student queries 504, each in association with a respective one of the plurality of responses in a second database (e.g., the experience database 110).

At block 908, the teaching feedback generator 136 identifies, from the first database, portions of the course materials 109, each based on a respective one of the plurality of responses that are generated by the at least one LLM 112 and stored in the second database. In other words, the teaching feedback generator 136 identifies portions of the course materials 109 that were used by the LLM 112 to generate respective ones of the plurality of responses.

At block 910, the teaching feedback generator 136 determines, based on the plurality of student queries 504 stored in the second database, a student learning performance indicating a student learning difficulty in at least a first learning concept associated with the specific course 502. In an embodiment, as part of determining the student learning performance, the teaching feedback generator 136 classifies the plurality of student queries 504 into a plurality of learning concepts including the first learning concept. The teaching feedback generator 136 further determines the student learning difficulty in the first learning concept based on a number of the plurality of student queries 504 associated with the first learning concept being high (e.g., exceeding a certain threshold). In an embodiment, the determining the student learning difficulty in the first learning concept is further based on the number of the plurality of student queries 504 associated with the first learning concept is greater than a number of the plurality of student queries associated with another learning concept of the plurality of learning concepts. For instance, the number of the plurality of student queries 504 associated with the first learning concept may be the highest among all the learning concepts. In other words, the first learning concept may be the most challenging concept for the student(s). In an embodiment, the plurality of learning concepts are based on learning concept goals for the specific course 502.

At block 912, the teaching feedback generator 136 analyzes the identified portions of the course materials 109 to determine an effectiveness of the course materials 109 in teaching at least a second learning concept associated with the specific course 502. In an embodiment, as part of analyzing the identified portions of the course materials 109 to determine the effectiveness of the course materials 109, the teaching feedback generator 136 may determine an issue associated with the second learning concept based on a number of the identified portions of the course materials 109 associated with the second learning concept being high (e.g., exceeding a certain threshold). In some instances, the second learning concept may be the same as the first learning concept (that is based on the number of student queries at block 910). This may be the case when the most frequently asked questions are all answered by the natural language-based TA agent 134 using the knowledge database 108. That is, the particular concept may be well addressed by the course materials 109. In other instances, the second learning concept may be different than the first learning concept. This may be the case when some of the most frequently asked questions were answered by the human instructor 150 (e.g., because the second concept may not be adequately addressed in the course materials 109 and hence the natural language-based TA agent 134 may have elevated the questions to the human instructor 150).

At block 914, the teaching feedback generator 136 generates a teaching feedback report associated with the specific human instructor 150, where the teaching feedback report includes an indication of the student learning performance and the effectiveness of the course materials 109. Generally, the teaching feedback generator 136 may generate and provide various feedback information, to the human instructor 150. For instance, the feedback information may include course material information (e.g., indicating topics that are not well addressed). Additionally or alternatively, the feedback information may include students 140′ learning performance and engagement. In an example, quizzes and/or exams can be generated based on the course materials 109, the quizzes and/or exams can also be graded based on the course materials 109, and the students 140′ learning performance can be collected based on the students 140′ scores from the quizzes and/or exams. Additionally or alternatively, the feedback information may include indications of learning resources that may be lacking for the students 140, for example, based on the conversation information from the interactions between the students 140 and the human instructor 150 (e.g., collected by the natural language-based TA agent 134 stored in the experience database 110).

In an embodiment, as part of generating the plurality of responses for the respective ones of the plurality of student queries 504 at block 904, the natural language-based TA agent 134 receives student feedback indicating that a response generated by the at least one LLM 112 is unsatisfactory for a first student query 504 of the plurality of student queries 504. The natural language-based TA agent 134 further transmits, to an instructor computing device 104 associated with the specific human instructor 150, the first student query 504 based on the student feedback indicating that the response generated by the at least one LLM 112 for the first student query 504 is unsatisfactory. In response, the natural language-based TA agent 134 receives, from the instructor computing device 104, a human instructor generated response to the first student query 504, where the determining the effectiveness of the course materials 109 at block 912 is further based on the human instructor generated response. In an embodiment, the human instructor generated response is associated with the second learning concept, and as part of determining the effectiveness of the course materials 109, the teaching feedback generator 136 determines that there is a lack of information associated with the second learning concept in the course materials 109 based on a comparison of the human instructor generated response and the course materials 109.

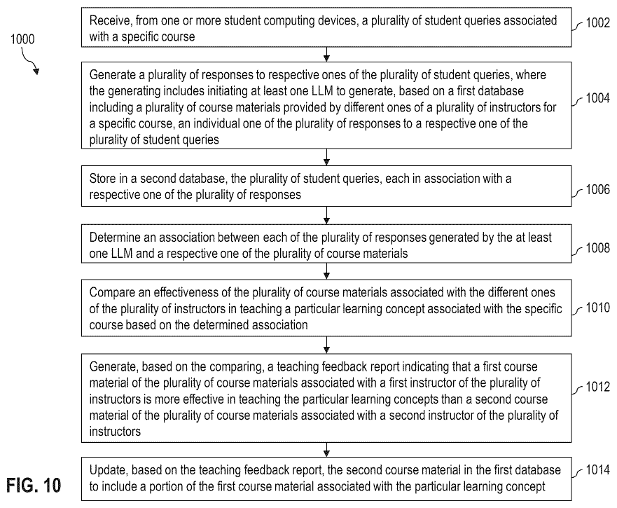

Turning now to FIG. 10, an example method 1000 is described. In an embodiment, the method 1000 is a method for providing teaching feedback across different instructors teaching the same course. The method 1000 may include similar mechanisms as discussed above with reference to FIGS. FIGS. 1, 2, 3A-3B, 4A-4B, and 6-8. The method 1000 may be implemented by the natural language-based TA agent 134 and the teaching feedback generator 136. In embodiments, the method 1000 may be implemented using a computer system with components as shown in FIG. 11. As illustrated, FIG. 10 includes a number of enumerated operations, but embodiments of the operations in FIG. 10 may include additional operations before, after, and in between the enumerated operations. In some embodiments, one or more of the enumerated operations may be omitted or performed in a different order.

At block 1002, the natural language-based TA agent 134 receives, from one or more student computing devices 102, a plurality of student queries 504.

At block 1004, the natural language-based TA agent 134 generates a plurality of responses to respective ones of the plurality of student queries 504. As part of generating the plurality of responses, the natural language-based TA agent 134 initiates at least one LLM 112 to generate, based on a first database (e.g., the knowledge database 108) including a plurality of course materials 109 provided by different ones of a plurality of instructors 150 (e.g., human instructors) for a specific course 502, an individual one of the plurality of responses for a respective one of the plurality of student queries 504. In an embodiment, each of the plurality of course materials 109 for the specific course 502 in the first database includes at least one of a lecture recording, a transcript of a lecture recording, lecture notes, a textbook, lecture slides, question-answer pairs provided by a respective one of the plurality of instructors 150.

At block 1006, the natural language-based TA agent 134 stores the plurality of student queries 504, each in association with a respective one of the plurality of responses in a second database (e.g., the experience database 110).

At block 1008, the teaching feedback generator 136 determines an association between each of the plurality of responses generated by the at least one LLM 112 and a respective one of the plurality of course materials 109.

At block 1010, the teaching feedback generator 136 compares an effectiveness of the plurality of course materials 109 associated with the different ones of the plurality of instructors 150 in teaching a particular learning concept associated with the specific course 502 based on the determined association at block 1008.

At block 1012, the teaching feedback generator 136 generates, based on the comparing at block 1010, a teaching feedback report indicating that a first course material 109 of the plurality of course materials 109 associated with a first instructor 150a of the plurality of instructors 150 is more effective in teaching the particular learning concepts than a second course material 109b of the plurality of course materials 109 associated with a second instructor 150 of the plurality of instructors 150. In an embodiment, the first course material 109 is associated with a different faculty than the second course material 109.

At block 1014, the teaching feedback generator 136 updates, based on the teaching feedback report at block 1012, the second course material 109b in the first database to include a portion of the first material 109a associated with particular learning concept. In some instances, the teaching feedback generator 136 may also delete a portion of the second course material 109a associated with the particular learning concept.

In an embodiment, as part of comparing the effectiveness of the plurality of course materials 109 associated with the different ones of the plurality of instructors 150 at block 1010, the teaching feedback generator 136 compares a number of the plurality of responses that are associated with a portion of the first course material 109 associated with the particular learning concept to a number of the plurality of responses that are associated with a portion of the second course material 109 associated with the particular learning concept. In an embodiment, as part of comparing the effectiveness of the plurality of course materials 109 associated with the different ones of the plurality of instructors 150 at block 1010, the teaching feedback generator 136 determines a difference in instructional styles between a portion of the first course material 109 associated with the particular learning concept and a portion of the second course material 109 associated with the particular learning concept. In an embodiment, as part of comparing the effectiveness of the plurality of course materials 109 associated with the different ones of the plurality of instructors 150 at block 1010, the teaching feedback generator 136 determines a difference in content between a portion of the first course material 109 associated with the particular learning concept and a portion of the second course material 109 associated with the particular learning concept.

In an embodiment, the teaching feedback generator 136 further determines that a third course material 109 of the plurality of course materials 109 associated with a third instructor 150 of the plurality of instructors 150 answered a greatest number of the plurality of student queries 504 among the plurality of course materials 109.

FIG. 11 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, RAM 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, USB interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as CDMA, global system for mobile communications (GSM), LTE, WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A computer-implemented method for artificial intelligence (AI)-driven interactive knowledge base evaluation, the method comprising:
receiving, by a first application comprising instructions stored in non-transitory memory of a computer system and executable by a processor of the computer system, a plurality of queries;
generating, by the first application, a plurality of responses to respective ones of the plurality of queries, wherein the generating comprises initiating at least one large-language model (LLM) to generate, based on a first database comprising a plurality of knowledge materials provided by different ones of a plurality of instructors, an individual one of the plurality of responses to a respective one of the plurality of queries;
storing, by the first application, in a second database, the plurality of queries, each in association with a respective one of the plurality of responses;
determining, by a second application comprising instructions stored in the non-transitory memory of the computer system and executable by the processor of the computer system, an association between each of the plurality of responses generated by the at least one LLM and a respective one of the plurality of knowledge materials;
comparing, by the second application, an effectiveness of the plurality of knowledge materials associated with the different ones of the plurality of instructors in teaching a particular concept based on the determined association;
generating, by the second application, based on the comparing, a feedback report indicating that a first knowledge material of the plurality of knowledge materials associated with a first instructor of the plurality of instructors is more effective in teaching the particular concept than a second knowledge material of the plurality of knowledge materials associated with a second instructor of the plurality of instructors; and
updating, by the second application, based on the feedback report, the second knowledge material in the first database to include a portion of the first knowledge material associated with the particular concept.

2. The method of claim 1, wherein the comparing the effectiveness of the plurality of knowledge materials associated with the different ones of the plurality of instructors comprises:
comparing, by the second application, a number of the plurality of responses that are associated with a portion of the first knowledge material associated with the particular concept to a number of the plurality of responses that are associated with a portion of the second knowledge material associated with the particular concept.

3. The method of claim 1, wherein the comparing the effectiveness of the plurality of knowledge materials associated with the different ones of the plurality of instructors comprises:
determining, by the second application, a difference in instructional styles between a portion of the first knowledge material associated with the particular concept and a portion of the second knowledge material associated with the particular concept.

4. The method of claim 1, wherein the comparing the effectiveness of the plurality of knowledge materials associated with the different ones of the plurality of instructors comprises:
determining, by the second application, a difference in content between a portion of the first knowledge material associated with the particular concept and a portion of the second knowledge material associated with the particular concept.

5. The method of claim 1, further comprising:
determining, by the second application, that a third knowledge material of the plurality of knowledge materials associated with a third instructor of the plurality of instructors answered a greatest number of the plurality of queries among the plurality of knowledge materials.

6. The method of claim 1, wherein the first knowledge material is associated with a different faculty than the second knowledge material.

7. The method of claim 1, wherein each of the plurality of knowledge materials in the first database comprises at least one of a lecture recording, a transcript of a lecture recording, lecture notes, a textbook, lecture slides, or a question and a corresponding answer provided by a respective one of the plurality of instructors.

8. A computer-implemented method for artificial intelligence (AI)-driven interactive knowledge base evaluation, the method comprising:
receiving, by a natural language-based teaching assistant (TA) agent comprising instructions stored in non-transitory memory of a computer system and executable by a processor of the computer system, from one or more student computing devices, a plurality of student queries associated with a specific course;
generating, by the natural language-based TA agent, a plurality of responses to respective ones of the plurality of student queries, wherein the generating comprises initiating at least one large-language model (LLM) to generate, based on a first database comprising course materials associated with the specific course and provided by a specific human instructor, an individual one of the plurality of responses for a respective one of the plurality of student queries;
storing, by the natural language-based TA agent, in a second database, the plurality of student queries, each in association with a respective one of the plurality of responses;
identifying, by a teaching feedback generator comprising instructions stored in the non-transitory memory of the computer system and executable by the processor of the computer system, from the first database, portions of the course materials, each based on a respective one of the plurality of responses that are generated by the at least one LLM and stored in the second database;
determining, by the teaching feedback generator, based on the plurality of student queries stored in the second database, a student learning performance indicating a student learning difficulty in at least a first learning concept associated with the specific course;
analyzing, by the teaching feedback generator, the identified portions of the course materials to determine an effectiveness of the course materials in teaching at least a second learning concept associated with the specific course; and
generating, by the teaching feedback generator, a teaching feedback report associated with the specific human instructor, wherein the teaching feedback report comprises an indication of the student learning performance and the effectiveness of the course materials.

9. The method of claim 8, wherein the plurality of student queries are associated with a specific student.

10. The method of claim 8, wherein the plurality of student queries are associated with a plurality of students.

11. The method of claim 8, wherein the determining the student learning performance comprises:
classifying, by the teaching feedback generator, the plurality of student queries into a plurality of learning concepts comprising the first learning concept; and
determining, by the teaching feedback generator, the student learning difficulty in the first learning concept based on a number of the plurality of student queries associated with the first learning concept.

12. The method of claim 11, wherein the determining the student learning difficulty in the first learning concept is further based on the number of the plurality of student queries associated with the first learning concept is greater than a number of the plurality of student queries associated with a third learning concept of the plurality of learning concepts.

13. The method of claim 11, wherein the plurality of learning concepts are based on learning concept goals for the specific course.

14. The method of claim 8, wherein the analyzing the identified portions of the course materials to determine the effectiveness of the course materials comprises:
determining, by the teaching feedback generator, an issue associated with the second learning concept based on a number of the identified portions of the course materials associated with the second learning concept.

15. The method of claim 8, wherein the generating the plurality of responses for the respective ones of the plurality of student queries further comprises:
receiving, by the natural language-based TA agent, student feedback indicating that a response generated by the at least one LLM is unsatisfactory for a first student query of the plurality of student queries;
transmitting, by the natural language-based TA agent, to an instructor computing device associated with the specific human instructor, the first student query based on the student feedback indicating that the response generated by the at least one LLM for the first student query is unsatisfactory; and
receiving, by the natural language-based TA agent, from the instructor computing device, a human instructor generated response to the first student query, and
wherein the determining the effectiveness of the course materials is further based on the human instructor generated response.

16. The method of claim 15, wherein the human instructor generated response is associated with the second learning concept, and wherein the determining the effectiveness of the course materials comprises:
determining, by the teaching feedback generator, that there is a lack of information associated with the second learning concept in the course materials based on a comparison of the human instructor generated response and the course materials.

17. The method of claim 8, wherein the course materials for the specific course in the first database comprises at least one of a lecture recording, a transcript of a lecture recording, lecture notes, a textbook, lecture slides, or a question and a corresponding answer provided by the specific human instructor.

18. A system for artificial intelligence (AI)-driven interactive knowledge base oversight, the system comprising:
at least one processor;
at least one non-transitory memory;
a first database comprising course materials associated with the specific course and the specific instructor;
a second database comprising a plurality of student queries, each in association with a respective one of a plurality of responses generated by at least one large-language model (LLM) based on the course materials in the first database; and
a teaching feedback generator comprising instructions stored in the at least one non-transitory memory and executable by the at least one processor, when executed by the processor, causes the teaching feedback generator to:
retrieve, from the second database, the plurality of student queries and corresponding plurality of responses generated by the at least one LLM;
identify, for each of the retrieved plurality of responses, a corresponding portion of the course materials from the first database;
determine, based on the retrieved plurality of student queries and the retrieved portion of the course materials corresponding to each of the plurality of responses, at least one of a:
first feedback associated with a student learning performance for the specific course; and
second feedback associated with the course materials; and
generate a teaching feedback report associated with the specific instructor, wherein the teaching feedback report comprises the at least one of the first feedback associated with the student learning performance or the second feedback associated with the course materials.

19. The system of claim 18, wherein the determining the first feedback associated with the student learning performance comprises:
identifying a student learning difficulty in a particular learning concept associated with the specific course based on a number of the retrieved portions of the course materials associated with the particular learning concept satisfying a threshold.

20. The system of claim 18, wherein the determining the second feedback associated with the course materials comprises:
determining an issue associated with a particular learning concept associated with the specific course in the course materials based on a number of the retrieved portions of the course materials associated with the particular learning concept satisfying a threshold.
